(19) United States
(12) Patent Application Publication
(10) Pub. No.: US 2026/0332078 A1
(43) Pub. Date: Oct. 22, 2026

(54) AUXILIARY POWER SUPPLIES USING MOTOR WINDING INDUCTANCE

(71) Applicant: POWER INTEGRATIONS, INC., San Jose, CA (US)

(72) Inventor: William Michael POLIVKA, Campbell, CA (US)

(73) Assignee: POWER INTEGRATIONS, INC., San Jose, CA (US)

(21) Appl. No.: 19/722,549

(22) Filed: Jun. 26, 2026

Related U.S. Application Data
(63) Continuation-in-part of application No. 19/303,197, filed on Aug. 18, 2025.
Application No. 19/303,197 is a continuation of application No. 18/085,887, filed on Dec. 21, 2022, now Pat. No. 12,413,167.

(51) Int. Cl. H02P 25/18; H02K 3/28; H02P 27/06

(52) U.S. Cl. CPC H02P 25/18; H02K 3/28; H02P 27/06

(57) ABSTRACT

A switching circuit of a motor driver is controlled according to a switching sequence that causes a winding current conducted through a winding of a motor to increase and store energy in an inductance of the winding. The switching sequence further causes at least a portion of the winding current to be diverted and either delivered to or removed from an auxiliary power supply. The switching circuit includes at least one high side switch, at least one low side switch, and an auxiliary node through which the winding current is diverted. The diverted winding current can provide the auxiliary power supply with an output voltage that is either positive or negative with respect to a reference voltage such as a voltage of an input return. The switching circuit can be controlled in conjunction with a switching circuit of another motor driver coupled to an opposite end of the winding.

### CROSS REFERENCE TO RELATED APPLICATIONS

This application is a continuation-in-part of U.S. application Ser. No. 19/303,197, filed Aug. 18, 2025, which is a continuation of U.S. application Ser. No. 18/085,887, filed Dec. 21, 2022 and issued as U.S. Pat. No. 12,413,167. Each of the above-listed applications is incorporated in its entirety herein by reference.

### BACKGROUND OF THE INVENTION

### Field of the Invention

The present invention relates generally to auxiliary power supplies used with motor drivers.

### Discussion of the Related Art

Motor drive inverters, e.g. half-bridge motor driver circuits, typically use an auxiliary power supply to generate the power source for the power transistor drivers and microprocessor that controls the operation of the motor.

Some half-bridge motor driver circuits include a self-starting feature that can support their operation indefinitely by using high voltage (HV) linear regulators deriving power from the same HV dc (direct current) bus that provides power to the motor. However, even if the half-bridge motor driver circuit can power itself, the additional power used by a system microcontroller and other circuitry generally results in excessive power dissipation from the linear regulator.

One previous solution is to have an auxiliary switching power supply, typically either a buck converter or a flyback converter, that efficiently derives power for the motor drive inverters directly from the high voltage bus through a dedicated inductive energy transfer element. This auxiliary power supply comes with the penalty of additional cost and consumption of space on a circuit board.

### SUMMARY OF THE DISCLOSURE

The present disclosure is generally directed to switch-based motor control systems and corresponding switch control schemes to provide an auxiliary power supply with a regulated output voltage by diverting motor winding current such that the diverted current is delivered to or, in some cases, removed (i.e., sourced) from an input of the auxiliary power supply. The example embodiments disclosed herein allow an output of an auxiliary power supply to be regulated in an efficient manner using fewer components compared to conventional solutions. For instance, a dedicated inductive energy transfer element is rendered unnecessary by virtue of repurposing switching circuitry that would normally be used to drive a motor into motion (e.g., rotation of a rotor), to also be used for generating current through the inductance of a motor winding and diverting winding current to or from an auxiliary power supply.

An auxiliary power supply typically has an output voltage that is negative with respect to (i.e., lower than) an input voltage VDD but positive with respect to (i.e., higher than) an input return. The input return may serve as a ground reference for one or more components in a motor control system (e.g., a motor driver circuit, a system controller, or some other component). The output of the auxiliary power supply may be used as a supply voltage for such components.

Examples are disclosed in which winding current is diverted using a first motor driver coupled to one end of a motor winding in combination with a switching circuit of a second motor driver coupled to an opposite end of the motor winding. The switching circuit of the second motor driver is further coupled to the auxiliary power supply and includes at least one high side switch and at least one low side switch. A switching circuit of the first motor driver may be controlled in conjunction with the switching circuit of the second motor driver to generate and divert the winding current. In some instances, a switching circuit may include more than one high side or low side switch.

One or more examples may be applied to provide an auxiliary power supply with an output that is a relatively low positive voltage with respect to input return, equivalent to a relatively high negative voltage with respect to VDD (e.g., much closer to the input return than to VDD). For instance, the output of the auxiliary power supply could be five volts (5V) or 12V when the input return is 0V and VDD is 300V. Additionally, some examples may provide an auxiliary voltage that is negative with respect to input return (e.g., −5V or −12V when the input return is 0V).

Alternatively, one or more examples may be applied to provide an auxiliary power supply with an output that is a relatively high positive voltage with respect to input return, equivalent to a relatively low negative voltage with respect to VDD (e.g., much closer to VDD than to the input return). For instance, the output of the auxiliary power supply could be 288V when the input return is 0V and VDD is 300V.

Accordingly, the disclosed examples collectively cover a wide range of motor applications and are suitable for meeting the power demands of a variety of components, including components with disparate operating voltages within the same motor control system. By way of illustration, a low negative voltage with respect to VDD may serve as a supply voltage for high side circuitry in a motor control system (e.g., circuits coupled directly to VDD), while a high negative voltage with respect to VDD may serve as a supply voltage for low side circuitry in the motor control system (e.g., circuits coupled directly to input return).

In general, the functionality described herein can be achieved using a motor driver comprising a switching circuit and control circuitry coupled to the switching circuit. In some examples, the switching circuit includes at least one high side switch, at least one low side switch, and an auxiliary node coupled to the auxiliary power supply (e.g., directly coupled to the auxiliary node or coupled using an interposing diode). The at least one high side switch and the at least one low side switch may be coupled together in a half bridge configuration (e.g., a half bridge that forms a full bridge, also referred to as an H-bridge, when combined with a half bridge of another motor driver). The control circuitry is configured to apply a switching sequence to the switching circuit. The switching sequence causes a winding current to increase while storing energy in an inductance of the winding. The switching sequence also causes at least a portion of the winding current to be diverted through the auxiliary node and either delivered to or removed from the auxiliary power supply via the auxiliary node.

In the example motor driver described above, the winding current can be increased by closing the at least one high side switch and opening the at least one low side switch in combination with an appropriate setting of switches in another motor driver that is coupled to an opposite end of the winding. For instance, to allow the winding current to increase, a high side switch of the other motor driver may be kept open, and a low side switch of the other motor driver may be kept closed. The winding current can be diverted to or from the auxiliary power supply by opening one or more switches, which may include a high side switch, a low side switch, or both a high side switch and a low side switch.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a functional block diagram showing an auxiliary power supply in a motor control system that includes a half-bridge motor driver circuit, in accordance with an embodiment of the present disclosure.

FIG. 2 is a functional block diagram showing the current path for an auxiliary power supply in a switched-mode power converter, in accordance with an embodiment of the present disclosure.

FIG. 3 is a timing diagram illustrating operation of an embodiment for obtaining current from a motor winding.

FIG. 4 is a timing diagram illustrating operation of an additional embodiment for obtaining current from a motor winding.

FIG. 5 is a timing diagram illustrating operation of an additional embodiment for obtaining current from a motor winding.

FIG. 6 is a timing diagram illustrating operation of an additional embodiment for obtaining current from a motor winding.

FIG. 7 is a timing diagram illustrating operation of an additional embodiment for obtaining current from a motor winding.

FIG. 8 is a timing diagram illustrating operation of an additional embodiment for obtaining current from a motor winding.

FIG. 9 is a circuit schematic illustrating an embodiment of a portion of the half bridge motor driver circuit shown in FIG. 1.

FIG. 10 is a circuit schematic illustrating an embodiment of a portion of the half-bridge motor driver circuit shown in FIG. 1.

FIG. 11 is a circuit schematic illustrating an embodiment of a portion of the half-bridge motor driver circuit shown in FIG. 1 that includes an auxiliary switch for the auxiliary power supply.

FIG. 12 is a circuit schematic of another embodiment of a portion of the half-bridge motor driver circuit shown in FIG. 1 that includes an auxiliary switch for the auxiliary power supply.

FIG. 13 is a timing diagram illustrating operation of an embodiment for obtaining current from a motor winding using the circuitry shown in FIG. 12.

FIGS. 14A, 14B, and 14C illustrate additional embodiments of the system shown in FIG. 1.

FIG. 15 is a functional block diagram in accordance with another embodiment of the present disclosure.

FIG. 16 is a process flowchart according to an embodiment of the present disclosure.

FIG. 17 is a functional block diagram of a motor control system in accordance an embodiment of the present disclosure.

FIG. 18 is a functional block diagram showing the current path for an auxiliary power supply in accordance with an embodiment of the present disclosure.

FIG. 19 is a circuit schematic illustrating an embodiment of a portion of the half-bridge motor driver circuit shown in FIG. 17.

FIG. 20 is a circuit schematic illustrating an embodiment of a portion of the half-bridge motor driver circuit shown in FIG. 17.

FIG. 21 is a circuit schematic illustrating an embodiment of a portion of the half-bridge motor driver circuit shown in FIG. 17.

FIG. 22 is a functional block diagram of a motor control system in accordance an embodiment of the present disclosure.

FIG. 23 is a timing diagram illustrating operation of an embodiment for obtaining current from a motor winding.

FIG. 24 is a timing diagram illustrating operation of an embodiment for obtaining current from a motor winding.

FIG. 25 is a circuit schematic of an embodiment of the half-bridge motor driver shown in FIG. 22.

FIG. 26 is a process flowchart according to an embodiment of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted to facilitate a less obstructed view of these various embodiments of the present invention.

### DETAILED DESCRIPTION

In the following description, numerous specific details are set forth to provide a thorough understanding of the present invention. It will be apparent, however, to one having ordinary skill in the art that the specific detail need not be employed to practice the present invention. In other instances, well-known materials or methods have not been described in detail to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or subcombinations in one or more embodiments or examples. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

A motor drive inverter, e.g., a configuration of one or more half-bridge motor driver circuits, may include control circuitry to control turn-on and turn-off of switches in a switching circuit coupled to a motor winding. In a first state, the switching circuit is configured to take current from a high voltage power source that powers the motor and to store energy in the winding as current in an inductance of the winding. In a second state, the switching circuit is configured to divert at least a portion of the current in the winding such that the diverted current is delivered to or removed (i.e., sourced) from the input of the auxiliary power supply. The first and second states are based on operating parameters of the auxiliary power supply, the motor, and the motor drive inverter. The operating parameters may include duty cycle (e.g., the ratio of the time a switch is in a first state to the total time in the first state plus the time in a second state), current in the winding, and the needs of an auxiliary power supply for input current to provide a regulated output voltage. The motor driver circuits may be housed within one or more electronic packages so that they can be used as part of a printed circuit board circuit. The control circuitry may be housed within the same electronic package as the motor driver circuits or as separate circuits housed in one or more other electronic packages. Control circuitry may comprise circuits such as microcontroller units (MCUs) that can be programmed to provide electronic signals to the motor driver circuits to control the currents in the motor windings to which they are coupled.

The inherent inductance of a motor winding is used as the energy storage element to perform the power conversion from the high voltage de bus to a substantially lower voltage at the input to the auxiliary power supply. In one embodiment, existing inverter power transistors may be used as the switching transistors that provide the current to/from the auxiliary power supply. Thus, switching power conversion for the auxiliary power supply reuses circuitry that already exists for the motor inverter operation and avoids the unacceptable power dissipation that could occur with a linear regulator. Furthermore, using the inductance of a motor winding eliminates the need to have a dedicated inductive energy transfer element in an auxiliary power supply that operates directly from the high voltage bus. In other words, the switches of the motor inverter may be switches in a switched-mode power converter having an inductive energy transfer element that is also a winding of a motor. The input of the switched-mode power converter may be the high voltage input source for the motor, and the output of the switched-mode power converter may be the input to an auxiliary power supply.

Some embodiments of the present disclosure may use existing inverter power switches such as field-effect transistors (FETs), insulated gate bipolar transistors (IGBTs), and enhancement mode Gallium Nitride transistors (GaN) etc. for the switch circuitry. Other embodiments may use a cascode power switch comprising a high voltage normally-on transistor, e.g., a normally-on GaN transistor, Silicon Carbide (SiC) transistor or junction field effect transistor (JFET), coupled to a cascode low voltage (LV) FET. In that configuration, the low voltage FET is turned off by the controller during a standard switch cycle to temporarily divert current from a motor winding such that the diverted current is either delivered to or removed from the input of an auxiliary power supply. Thus, the switching circuitry may be used to power both the driver integrated circuits (ICs) and auxiliary circuitry such as a system microcontroller unit (MCU) during either normal motor operation or when the motor is stationary.

When the motor is stationary, some of the inverter switches may be turned on for a short time to provide current for a relatively low power auxiliary power supply to power the auxiliary circuitry. For illustrative purposes, a short time is less than what is typically used to move the motor. The auxiliary circuitry receiving power from the auxiliary power supply can include the power switch drivers, system MCU, and ICs. For purposes of illustration, the power used for system MCU ICs in standby will be typically between 3 milliwatts and 10 milliwatts. The motor winding currents generated may be controlled to be of a sufficiently low value during any switching cycle such that negligible force is generated to limit motion of the motor. Furthermore, the frequency of switching will be restricted such that motor inertia, friction, and loading may also minimize motor movement.

When the motor is in motion, some of the inverter switches may be turned off for a relatively short time within a typical inverter switching cycle to provide current for the relatively low power auxiliary power supply to power the auxiliary circuitry. The motor winding currents may be controlled to increase the current in the winding above a value that results in motor motion. Furthermore, the frequency of switching may be restricted until there is sufficient current to produce motion of the motor and still provide current to the auxiliary power supply.

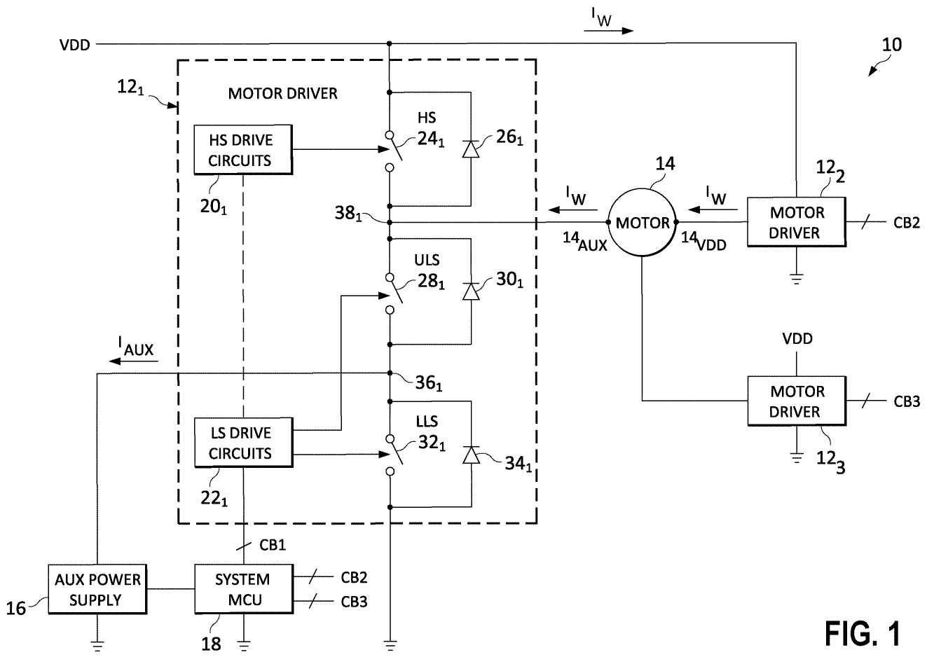

FIG. 1 is a functional block diagram 10 of a motor control system in accordance an embodiment of the present disclosure. Motor control system includes a motor 14, a set of motor driver circuits, an auxiliary power supply 16, and a system MCU 18. The example of FIG. 1 features three half-bridge motor driver circuits 12₁, 12₂, 12₃. The total number of motor driver circuits may differ in other embodiments. The motor drivers can have other switch configurations besides a half-bridge configuration. In general, each motor driver includes a set of switches and is coupled to one end of a winding (not shown) of the motor 14. The motor 14 may include more than one winding, with at least one motor driver being coupled to each winding.

Each of the half-bridge motor driver circuits 12₁, 12₂, 12₃ is coupled between VDD (typically a high voltage dc source serving as the input voltage on a positive supply rail) and an input return (typically a low or zero voltage dc source serving as the reference voltage on a negative supply rail). At least one motor driver circuit is further coupled to the auxiliary power supply 16. For illustration purposes, FIG. 1 shows only motor driver 12₁ as being coupled to auxiliary power supply 16. Motor driver 12₁ is representative of the other motor drivers 12₂ and 12₃, which may have circuitry similar to that of motor driver 12₁. The circuitry within a motor driver may collectively be referred to as a switching circuit. In addition to a set of switches, the switching circuit can include drive circuitry to turn on (close) and turn off (open) the switches under the control of system MCU 18. The drive circuitry in a motor driver may include high side (HS) drive circuits (e.g., 20₁) and low side (LS) drive circuits (e.g., 22₁). For illustration purposes, the discussion of FIG. 1 assumes that the motor drivers have identical switching circuits. Although the switching circuits can be identical, in practice, only one motor driver would typically be coupled to provide an auxiliary power supply that is shared with the other motor drivers. In that case, the switching circuits of the other motor drivers could be simplified to reduce circuit complexity and manufacturing cost.

System MCU 18 is configured to provide control signals CB1, CB2, CB3 to the drive circuitry of the motor drivers 12₁, 12₂, 12₃, respectively. It is appreciated that each signal, CB1, CB2, and CB3, may comprise two or more signal lines in an actual implementation and are therefore notated as signal buses. MCU 18 is one example of control circuitry discussed above which, in the embodiment of FIG. 1 is shown as being external to the motor drivers 12₁, 12₂, 12₃. In other embodiments, the functionality of MCU 18 may be implemented using control circuitry integrated within one of the motor drivers 12₁, 12₂, or 12₃.

The switching circuit of a motor driver generally includes at least one high side (HS) switch and at least one low side (LS) switch. The number of HS switches and the number of LS switches in a motor driver can vary. In the example of FIG. 1, motor driver 12₁ includes one HS switch and two LS switches. Other possible switch configurations (e.g., two HS switches and one LS switch) are described below in connection with later examples.

Half-bridge motor driver circuit 12₁ includes a HS switch 24₁ in parallel with a diode 26₁. The HS switch 24₁ is coupled between VDD and a winding of motor 14. The HS switch 24₁ is configured to be driven by the HS drive circuits 20₁. An upper low side (ULS) switch 28₁ is in parallel with a ULS diode 30₁. The ULS switch 28₁ is coupled to the same motor winding, at a winding node 38₁, and to the auxiliary power supply 16 at an auxiliary (AUX) node 36₁. A lower low side (LLS) switch 32₁ is in parallel with a LLS diode 34₁. The LLS switch 32₁ is coupled between the AUX node 36₁ and reference ground. In this example, the reference ground for the low side components (e.g., LS drive circuits) in each of the motor drivers is the input return, which is depicted using a ground symbol. The high side components (e.g., HS drive circuits) in each of the motor drivers may have a separate ground reference. For example, the HS drive circuits 20₁ may be referenced to the voltage at the winding node 38₁. However, the ground references for the LS drive circuits and/or the HS drive circuits may differ across embodiments depending on how the switches are implemented (e.g., using an n-channel MOSFET, a p-channel MOSFET, or some other type of switch).

Both the ULS and LLS switches 28₁, 32₁ are configured to be driven by the LS drive circuits 22₁. The HS switch 24₁,the ULS switch 28₁, and the LLS switch 32₁ are coupled together in sequential order, one after another, to collectively form a half-bridge (e.g., one leg of an H-bridge in which the other leg is formed by the switching circuit of another motor driver at the opposite end of the motor winding). The auxiliary power supply 16 is coupled between the AUX node 36₁ and reference ground. Examples of an auxiliary power supply include a low voltage switched-mode power supply and a linear regulated power supply.

The operation of the energy storage and current delivery is illustratively described using the example in FIG. 1 of the winding of motor 14 coupled to two half-bridge motor driver circuits 12₁, 12₂. Two half-bridge motor driver circuits 12₁, 12₂ are used to conduct current that may store energy in the winding of motor 14 and to deliver the current to the auxiliary power supply 16. Each half-bridge motor driver circuit 12₁, 12₂ configures its respective switching circuit in response to receiving its corresponding control signal CB1, CB2, transmitted by the system MCU 18. Switching signals within the half-bridge motor driver circuits indicate when to increase or decrease current in the winding and when to deliver a portion of the current I_{W} from the AUX node 36₁ to the auxiliary power supply 16.

It is appreciated that in a typical motor, the winding of motor 14 could be made up of several windings, often referred to as phase windings, but are consolidated into a single winding for simplicity in this description. For any individual winding, the current conducted through the winding can be controlled by coordinating the opening and closing of the switches in motor drivers located at opposite ends of the winding.

To increase current in the winding, the HS switch (not shown) in the half-bridge motor driver circuit 12₂ at a first end 14_{VDD} of the winding of motor 14 is closed. A switch that is closed may conduct current, whereas a switch that is open conducts negligible current. In the half-bridge motor driver circuit 12₁ that couples to the auxiliary power supply 16 and to a second end 14_{AUX} of the winding of motor 14, the HS switch may be opened and the ULS and LLS switches 28₁, 32₁ may be closed and opened in an appropriate manner to drive the motor and to provide current to the auxiliary power supply, while the HS switch of motor driver circuit 12₂ remains closed to provide a path to VDD.

For the half-bridge motor driver circuit 12₁ at the second end 14_{AUX} of the winding, to establish current I_{W} in the winding, the HS switch 24₁ may be opened and switches ULS 28₁ and LLS 32₁ may be closed. Then to deliver the current I_{W} in the winding to the auxiliary power supply 16, the HS switch 24₁ may remain open while the ULS switch 28₁ may remain closed and the LLS switch 32₁ may be opened. Opening the LLS switch 32₁ diverts the winding current I_{W} to the auxiliary power supply 16.

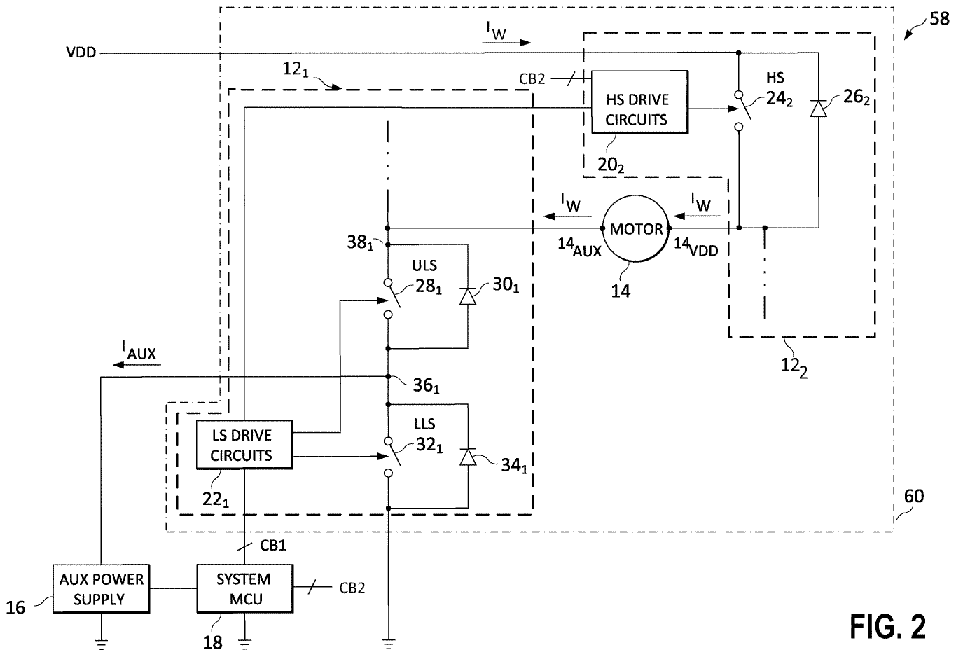

FIG. 2 is a functional block diagram 58 showing the current path for an auxiliary power supply in a switched-mode power converter 60, in accordance with an embodiment of the present disclosure. The switched-mode power converter 60 is coupled between VDD and reference ground, and further coupled to the auxiliary power supply 16 and the system MCU 18. The switched-mode power converter is a dc-to-dc converter that stores energy from a high voltage input VDD and delivers the energy at a lower voltage to the input of the auxiliary power supply.

The switched-mode power converter 60 in the example of FIG. 2 includes a winding of a motor 14, the high side circuitry of the half-bridge motor driver circuit 12₂, and the low side circuitry of the half-bridge motor driver circuit 12₁. In this example, the low side switch circuit of the motor driver 12₂ and the high side switch circuit of the motor driver 12₁ are inactive and are therefore not depicted. These inactive circuits may have functions beyond diverting winding current (or may be used in alternative switching sequences to divert current) and, as such, may become active at certain times. However, in some embodiments, the inactive switch circuitry may be omitted in whole or in part (e.g., so that the motor driver 12₂ has only one low side switch and one high side switch or, in cases where the motor is designed to operate with unidirectional current, a low side switch and a high side diode 26₂ but no high side switch 24₂). Accordingly, the motor drivers 12₁ and 12₂ in FIG. 2 may respectively comprise all or part of the motor drivers 12₁ and 12₂ shown in FIG. 1.

The high side circuitry of the motor driver includes a HS switch 24₂ in parallel with a diode 26₂, and HS drive circuits 20₂. The HS switch 24₂ is coupled between VDD and the winding of the motor 14.

The low side circuitry of the motor driver 12₁ includes a ULS switch 28₁ in parallel with a ULS diode 30₁, a LLS switch 32₁ in parallel with a LLS diode 34₁, and LS drive circuits 22₁.

The system MCU 18 is configured to provide control signal CB1 to the LS drive circuits 22₁ and control signal CB2 to the HS drive circuits 20₂.

In operation, the winding of motor 14 may be coupled between the HS switch 24₂ and the ULS switch 28₁. The switching circuits of the motor drivers 12₁, 12₂ collectively operate to conduct current that may store energy in the winding of motor 14 and may deliver a portion of the energy as current to the auxiliary power supply 16. The switching circuits respond to the control signals CB1, CB2 transmitted by the system MCU 18.

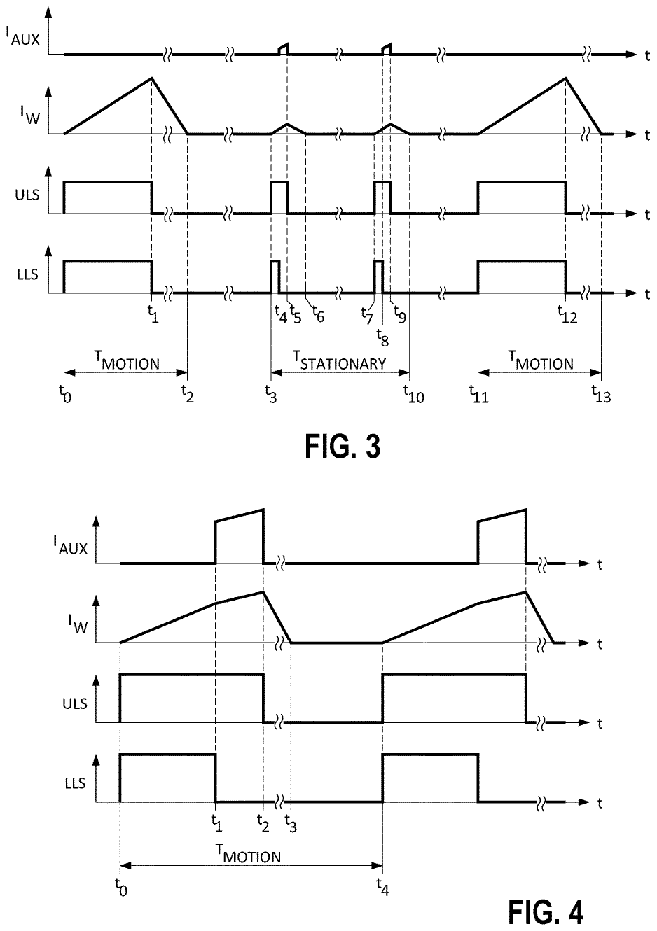

The LS drive circuits 22₁ of the motor driver 12₁ respond to the control signal CB1, while the HS drive circuits 20₂ of the motor driver 12₂ respond to the control signal CB2. The control signals CB1, CB2 may be transmitted by the system MCU 18 in accordance with one of the timing diagrams disclosed in FIGS. 3-7. In this example, the HS switch 24₂ of the motor driver 12₂ at the first end 14_{VDD} of the winding is shown as initially being open but can be closed to deliver current I_{W} to the winding when it receives a drive signal from the HS drive circuits 20₂. Alternatively, in another example, the winding current I_{W} can be delivered by closing a low side switch of the motor driver 12₂, in which case the winding current I_{W} would be conducted from the input return through the low side switch of the motor driver 12₂. In combination with an appropriate setting of the switches in the motor driver 12₂, the ULS and LLS switches 28₁, 32₁ of the motor driver 12₁ at the second end 14_{AUX} of the winding may switch appropriately to increase and decrease current in the winding and to deliver a portion of the current I_{W} from the AUX node 36₁ to the auxiliary power supply 16 when the auxiliary power supply 16 requires it.

FIGS. 3-8 are timing diagrams illustrating operation of embodiments for obtaining an auxiliary current I_{AUX} from the winding current I_{W} in the motor winding as shown in the example functional block diagram of FIG. 2. In operation, the winding current I_{W} may be increased without generating continuous motor motion when the motor is stationary and the switching circuitry is configured to deliver auxiliary current I_{AUX}. The winding current I_{W} may be increased above a threshold that generates motor motion when the motor is in motion and the switching circuitry is configured to deliver auxiliary current I_{AUX}.

FIG. 3 is a timing diagram illustrating operation of an embodiment for obtaining current from a motor winding. In FIG. 3, Graph LLS shows the state of the LLS switch 32₁ in the functional block diagram of FIG. 2. Graph ULS shows the state of the ULS switch 28₁ in the functional block diagram of FIG. 2. A high state indicates that the switch is closed, whereas a low state indicates that the switch is open. Graph I_{W} shows the current in the winding of motor 14. In FIG. 2, a positive current I_{W} indicates current in the direction from the second end 14_{AUX} of the winding to node 38₁ (along the direction of the arrow) whereas a negative current I_{W} indicates current flowing from node 38₁ to the second end 14_{AUX} of the winding (against the direction of the arrow). Graph I_{AUX} shows current at the input to the auxiliary power supply 16. For the purposes of discussing FIGS. 3-8 and other examples based on FIG. 2, when a positive current I_{W} is present and increasing in the motor winding, it is assumed that the HS switch in the motor driver 12₂ coupled to the first end 14_{VDD} of the motor winding is closed and the HS switch 24₁ (shown in FIG. 1) in the motor driver 12₁ coupled to the second end 14_{AUX} of the motor winding is open in order to allow current in the motor winding.

In FIG. 3, auxiliary current I_{AUX} is delivered to the input of the auxiliary power supply 16 when the motor 14 is stationary during the duration T_{STATIONARY}.

When the motor is in motion during the time T_{MOTION}, the ULS and LLS switches 28₁, 32₁ are closed at t₀, and current I_{W} from the HV dc bus VDD begins to increase in the winding. At t₁, the ULS and the LLS switches 28₁, 32₁ are opened to allow the winding current I_{W} to return to the VDD power supply rail through diode 26₁. The winding current I_{W} starts to decrease (e.g., at approximately the same rate as the increase between t₀ and t₁). At t₂, current I_{W} reaches its lowest value and there is negligible current in the winding. FIG. 3 shows T_{MOTION} as ending at time t₂. In actuality, the motor can continue to move for some time after the winding current I_{W} reaches zero, depending on the momentum and inertia of the motor, friction, loading, or other factors. In some cases, the movement of the motor may even carry over to a subsequent switching cycle (e.g., at least until the next time the winding current is increased, as shown in FIGS. 4-7).

When the motor is stationary during time T_{STATIONARY}, the ULS and LLS switches 28₁, 32₁ are closed at t₃, and the winding current I_{W} begins to increase. At t₄, when the winding current I_{W} reaches a threshold, the LLS switch 32₁ is opened to allow the winding current I_{W} to be delivered to the auxiliary power supply 16, and the current I_{AUX} is equal to the winding current I_{W}. In another embodiment, only a part of the winding current I_{W} is delivered and the auxiliary current I_{AUX} is a portion of I_{W}. The winding current I_{W} continues to increase.

FIG. 3 depicts the increase in winding current I_{W} (e.g., from t₀ to t₁) and the decrease in winding current I_{W} (e.g., from t₁ to t₂) with different slopes. However, the figures are not drawn to scale. Unless expressly indicated in the description, it should not be assumed that the rate of decrease is faster than the rate of increase or vice versa. In many instances, the switching circuitry is controlled such that the voltage across the winding during the ramp-up period (when the winding current is ramping up/increasing) and the voltage across the winding during the ramp-down period (when the winding current is ramping down/decreasing) are equal in magnitude but opposite in polarity. As such, the rate of increase and the rate of decrease in the winding current I_{W} are often the same or almost identical. However, as will be described in later examples, it is possible to control the switching circuitry to achieve different rates of increase and decrease using specific switch combinations and switching sequences.

At t₅, the ULS switch 28₁ is opened to allow winding current I_{W} to return to the VDD power supply rail through diode 26₁, for example, and the auxiliary current I_{AUX} reaches its lowest value, which in one example could be substantially zero or negligible current. The winding current I_{W} starts to decrease (e.g., at approximately the same rate as the increase between t₃ and t₄). At t₆, there is negligible current in the winding. The events repeat at times t₇, t₈, and t₉ to provide auxiliary current I_{AUX} to the input of the auxiliary power supply 16.

In the above and subsequent descriptions below it is appreciated that, in a practical motor control system, during time T_{STATIONARY}, the introduction of current I_{AUX} to provide an auxiliary power supply may initially introduce a small torque that is applied to the rotor of the motor in the system. As such, an initial small angular motion in the motor rotor may be introduced for the first few pulses of current I_{AUX} supplied to the auxiliary power supply during T_{STATIONARY}. However, this motion is temporary since during T_{STATIONARY}, the motor winding currents are not excited in a sequence to generate continuous motion as is the case during T_{MOTION}. As such, the period T_{STATIONARY} shall be referred to as the motor being stationary rather than the continuous rotation that is the case during T_{MOTION}.

FIG. 4 is a timing diagram illustrating operation of an additional embodiment for obtaining current from a motor winding. In FIG. 4, auxiliary current I_{AUX} is delivered to the input of the auxiliary power supply 16 when the motor 14 is in motion during time T_{MOTION}.

At t₀, the ULS and LLS switches 28₁, 32₁ are closed. Winding current I_{W} begins to increase. At t₁, the LLS switch 32₁ is opened to allow auxiliary current I_{AUX} to enter the auxiliary power supply 16. Winding current I_{W} continues to increase, but at a slower rate due to a decrease in the voltage across the winding. At t₂, the ULS switch 28₁ is opened and the current I_{W} starts to decrease (e.g., at approximately the same rate as the increase between t₀ and t₁). At t₃, there is negligible current in the winding. The sequence repeats at time t₄.

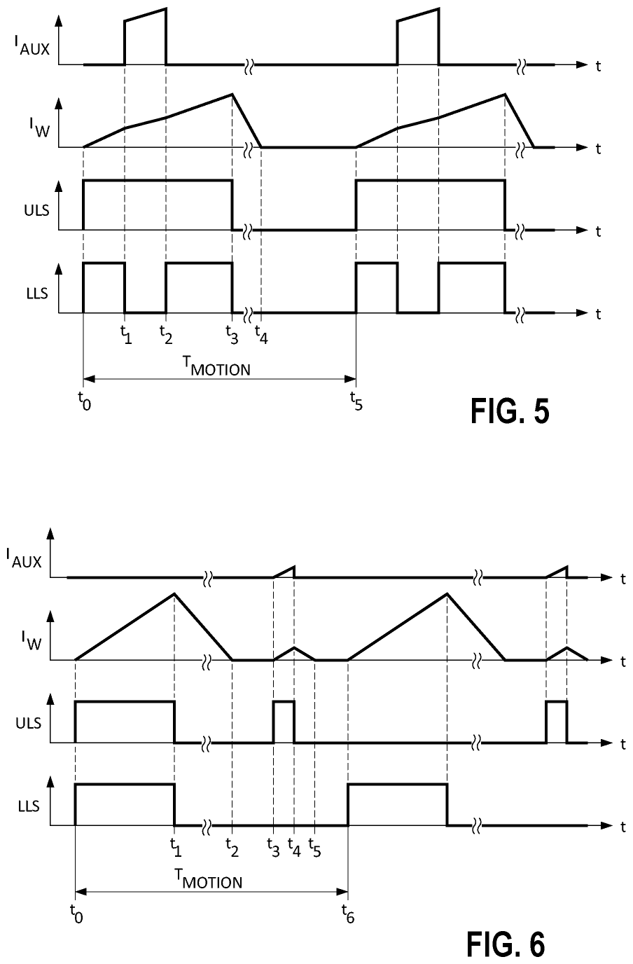

FIG. 5 is a timing diagram illustrating operation of an additional embodiment for obtaining current from a motor winding. In FIG. 5, auxiliary current I_{AUX} is delivered to the input of the auxiliary power supply 16 when the motor 14 is in motion during time T_{MOTION}. In this example, the winding current I_{W} is delivered once to the auxiliary power supply 16 (in the form of auxiliary current I_{AUX}) and is then returned to the VDD power supply rail.

At t₀, the ULS and LLS switches 28₁, 32₁ are closed. Winding current I_{W} begins to increase. At t₁, the LLS switch 32₁ is opened to allow auxiliary current I_{AUX} to enter the auxiliary power supply 16. Winding current I_{W} continues to increase, but at a slower rate due to a decrease in the voltage across the winding.

At t₂, the LLS switch 32₁ is closed and auxiliary current I_{AUX} goes to zero while winding current I_{W} continues to increase (e.g., at approximately the same rate as the increase between t₀ to t₁). At t₃, the ULS and LLS switches 28₁, 32₁ are opened to allow winding current I_{W} to return to the VDD power supply rail, for example, through the diode 26₁ of the motor driver 12₁ and while the high side switch 24₁ of the motor driver 12₁ remains open. The winding current I_{W} starts to decrease (e.g., at approximately the same rate as the increase between t₀ and t₁ or between t₂ and t₃). At t₄, there is negligible current in the winding.

FIG. 6 is a timing diagram illustrating operation of an additional embodiment for obtaining current from a motor winding. In FIG. 6, auxiliary current I_{AUX} is delivered to the input of the auxiliary power supply 16 when the motor 14 is in motion during time T_{MOTION}.

At t₀, the ULS and LLS switches 28₁, 32₁ are closed. Winding current I_{W} begins to increase. At t₁, the ULS and LLS switches 28₁, 32₁ are opened to allow winding current I_{W} to return to the VDD power supply rail, e.g., through the diode 26₁ of the motor driver 12₁. The winding current I_{W} starts to decrease (e.g., at approximately the same rate as the increase between t₀ and t₁). At t₂, there is negligible current in the winding.

At t₃, the ULS switch 28₁ is closed, winding current I_{W} increases in the winding and auxiliary current I_{AUX} is delivered to the input of the auxiliary power supply 16. At t₄, the ULS switch 28₁ is opened to allow winding current I_{W} to return to the VDD power supply rail, e.g., through the diode 26₁ of the motor driver 12₁. The winding current I_{W} starts to decrease. At t₅, there is negligible current in the winding.

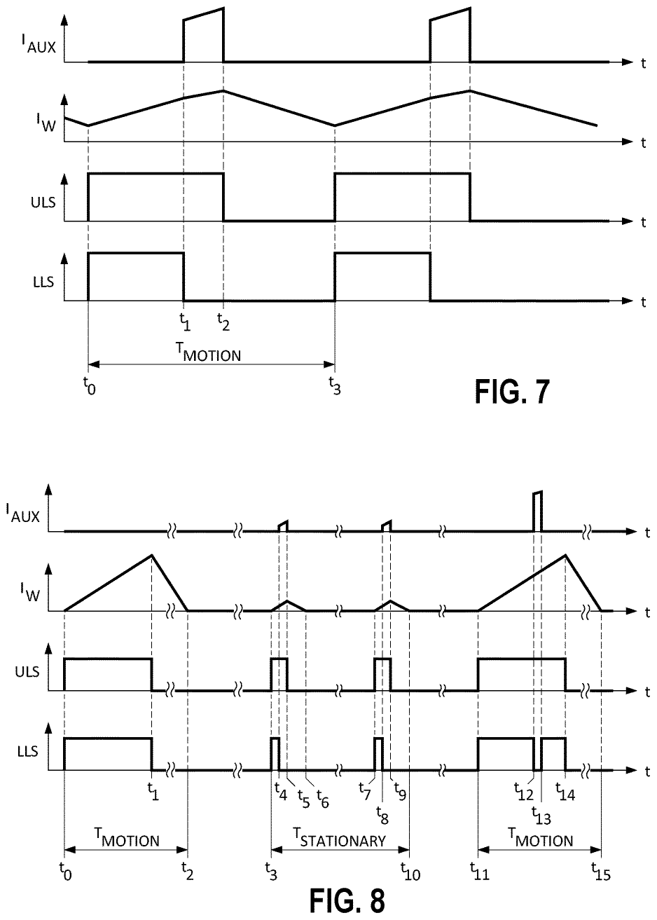

FIG. 7 is a timing diagram illustrating operation of an additional embodiment for obtaining current from a motor winding. In FIG. 7, auxiliary current I_{AUX} is delivered to the input of the auxiliary power supply 16 when the motor 14 is in motion during time T_{MOTION}.

At t₀, the ULS and LLS switches 28₁, 32₁ are closed. Winding current I_{W} begins to increase from a non-zero value. At t₁, the LLS switch 32₁ is opened to allow auxiliary current I_{AUX} to enter the input of the auxiliary power supply 16. Winding current I_{W} continues to increase, but at a slower rate due to a decrease in the voltage across the winding. At t₂, the ULS switch 28₁ is opened to stop auxiliary current I_{AUX} from entering input of the auxiliary power supply, allowing winding current I_{W} to return to the VDD power supply rail, e.g., through the diode 26₁ of the motor driver 12₁. The winding current I_{W} starts to decrease (e.g., at approximately the same rate as the increase between t₀ and t₁). At t₃, winding current I_{W} again increases from a non-zero value.

FIG. 8 is a timing diagram illustrating operation of an additional embodiment for obtaining current from a motor winding. In FIG. 8, auxiliary current I_{AUX} is delivered at multiple intervals when the motor is in motion during time T_{MOTION} and when the motor is stationary during time T_{STATIONARY}.

When the motor is in motion T_{MOTION}, at t₀, the ULS and LLS switches 28₁, 32₁ are closed. Winding current I_{W} begins to increase. At t₁, the ULS and the LLS switches 28₁, 32₁ are opened to allow winding current I_{W} to return to the VDD power supply rail, e.g., through the diode 26₁ of the motor driver 12₁. There is no switching to deliver current to the input of the auxiliary power supply (i.e., auxiliary current I_{AUX} is zero). The winding current I_{W} starts to decrease (e.g., at approximately the same rate as the increase between t₀ and t₁). At t₂, there is negligible current in the winding.

When the motor is stationary during time T_{STATIONARY}, at t₃, the ULS and LLS switches 28₁, 32₁ are closed. Winding current I_{W} begins to increase. At t₄, the LLS switch 32₁ is opened to allow auxiliary current I_{AUX} to enter the input of the auxiliary power supply 16. At t₅, the LLS switch 28₁ is opened to allow winding current I_{W} to return to the VDD power supply rail, e.g., through the diode 26₁ of the motor driver 12₁. The winding current I_{W} starts to decrease (e.g., at approximately the same rate as the increase between t₃ and t₄). At t₆, there is negligible current in the winding. The sequence may repeat at times t₇, t₈, t₉, and t₁₀ to provide current to the input of the auxiliary power supply.

When the motor is in motion during time T_{MOTION}, at t₁₁, the ULS and LLS switches 28₁, 32₁ are closed. Current I_{W} begins to increase. At t₁₂, the LLS switch 32₁ is opened to allow current I_{AUX} to enter the input of the auxiliary power supply 16. At t₁₃, the LLS switch 28₁ is closed. At t₁₄, the ULS and LLS switches 28₁, 32₁ may be opened to allow winding current I_{W} to return to the VDD power supply rail, e.g., through the diode 26₁ of the motor driver 12₁. The winding current I_{W} starts to decrease (e.g., at approximately the same rate as the increase between t₁₁ and t₁₂). At t₁₅, there is negligible current in the winding.

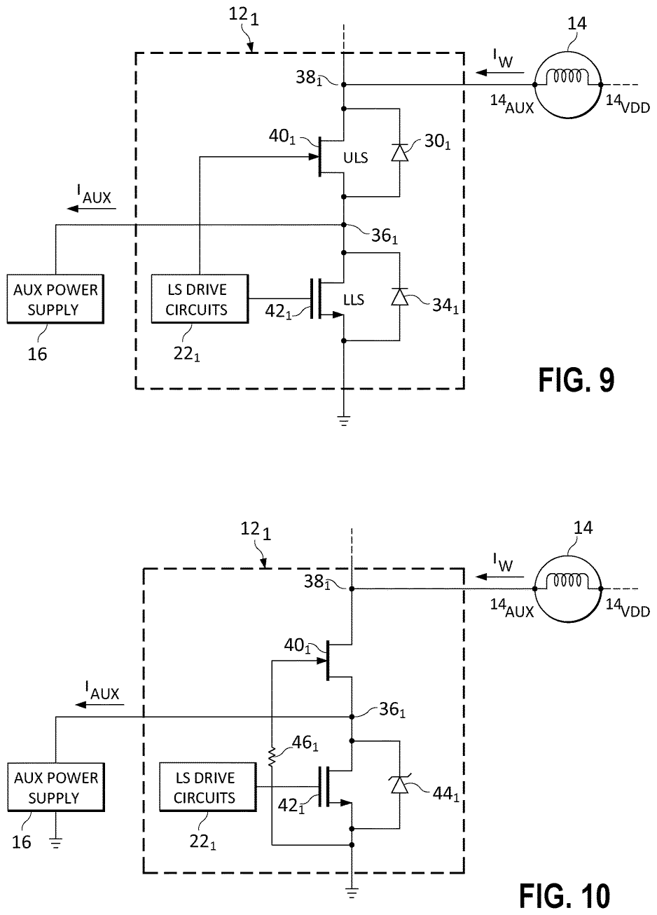

FIG. 9 is a circuit schematic of an embodiment of the half-bridge motor driver 12₁ shown in FIG. 1. In this example, the ULS switch 28₁ is implemented using a normally-on (e.g., depletion mode) transistor 40₁ that has a drain coupled to the second end 14_{AUX} of the motor winding to receive winding current I_{W},and a source coupled to the AUX node 36₁. Further, the LLS switch 32₁ is implemented using a normally-off (e.g., enhancement mode) transistor 42₁ that has a drain coupled to the AUX node 36₁ and a source coupled to reference ground. In some embodiments, the normally-on transistor 40₁ is a gallium nitride (GaN) transistor or silicon-based, junction field-effect transistor (JFET), and the normally-off transistor 42₁ is a metal-oxide-semiconductor field-effect transistor (MOSFET).

The LS drive circuits 22₁ are configured to receive a control signal from the system MCU 18 (e.g., control signal CB1 in FIG. 1) and to, responsive to the control signal, send switching signals to the transistors 40₁, 42₁. The switching signals indicate when to increase current in the winding and when to deliver the current via the AUX node 36₁ to the auxiliary power supply 16. It is appreciated that diode 30₁ and/or diode 34₁ could be inherent to the internal structure of its respective switch (e.g., an intrinsic body diode of transistor 40₁ or transistor 42₁) rather than being a discrete diode.

FIG. 10 is a circuit schematic of an embodiment of the half-bridge motor driver 12₁ shown in FIG. 1. Like the example of FIG. 9, the ULS switch 28₁ and the LLS switch 32₁ are respectively implemented using a normally-on transistor 40₁ (e.g., a GaN transistor or JFET) and a normally-off transistor 42₁ (e.g., a MOSFET). The normally-on transistor 40₁ has a drain coupled to the second end 14_{AUX} of the motor winding to receive winding current I_{W},and a source coupled to the AUX node 36₁. The normally-off transistor 42₁ has a drain coupled to the AUX node 36₁ and a source coupled to reference ground.

Unlike in FIG. 9, in response to the control signal from the system MCU 18 (e.g., control signal CB1 in FIG. 1), the LS drive circuits 22₁ are configured to send a switching signal to a control terminal (e.g., gate) of the normally-off transistor 42₁ without also sending a switching signal to a control terminal of the normally-on transistor 40₁. The switching signal sent to the normally-off transistor 42₁ indicates when to increase current in the winding and when to deliver current via the AUX node 36₁ to the auxiliary power supply 16. Further, a resistor 46₁ is coupled between reference ground and the control terminal (e.g., gate) of the normally-on transistor 40₁. In one embodiment, a Zener diode 44₁ is coupled in parallel to the normally-off transistor 42₁ to provide a clamp to limit the maximum voltage at AUX node 36₁ relative to reference ground.

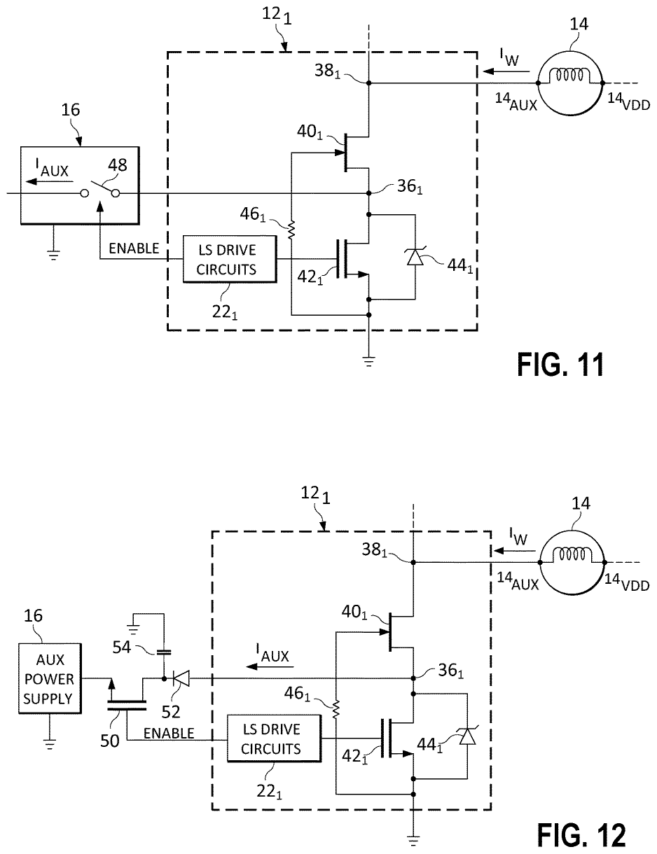

FIG. 11 is a circuit schematic of an embodiment of the half-bridge motor driver 12₁ shown in FIG. 1. In FIG. 11, a normally-on transistor 40₁, a normally-off transistor 42₁, a resistor 46₁, and a Zener diode 44₁ couple and function in a similar manner as in the example of FIG. 10. However, in addition to sending a switching signal to the control terminal (e.g., gate) of the normally-off transistor 42₁, the LS drive circuits 22₁ are configured to send an ENABLE signal to an auxiliary switch 48. The auxiliary switch 48 may be part of the auxiliary power supply 16 and is coupled between the AUX node 36₁ and an input of the auxiliary power supply 16. The auxiliary switch 48 may be a GaN transistor. The ENABLE signal controls turn-on and turn-off of the auxiliary switch 48 and indicates when to deliver current via the AUX node 36₁ to the auxiliary power supply 16.

FIG. 12 is a circuit schematic of an embodiment of the half-bridge motor driver 12₁ shown in FIG. 1. In FIG. 12, a normally-on transistor 40₁, a normally-off transistor 42₁, a resistor 461, and a Zener diode 441 couple and function in a similar manner as in the examples of FIGS. 10 and 11. However, the auxiliary switch 48 shown in FIG. 11 is implemented using a transistor 50 (e.g., an n-channel MOSFET) and is external to the auxiliary power supply 16. Further, unlike in FIGS. 10 and 11, the example of FIG. 12 includes a diode 52 and a capacitor 54. The diode 52 is coupled between the AUX node 36₁ and the auxiliary power supply 16. More specifically, the diode 52 has a cathode coupled to an input (e.g., drain) of the transistor 50 and an anode coupled to the AUX node 36₁. Capacitor 54 is coupled between the cathode of diode 52 and reference ground.

The circuit arrangement in FIG. 12 allows the auxiliary current I_{AUX} to charge the capacitor 54. When the transistor 50 is open, all the auxiliary current I_{AUX} is delivered to the capacitor 54. When the transistor 50 is closed, a portion of the auxiliary current I_{AUX} is delivered to the capacitor 54, while the remaining portion is delivered to the auxiliary power supply 16 through transistor 50. The maximum voltage to which the capacitor 54 can be charged is limited by the Zener diode 44₁. This is because the Zener diode 441 will start to conduct once the voltage at the AUX node 36₁ exceeds the reverse breakdown voltage of the Zener diode, thereby diverting at least some of the current that would otherwise form the auxiliary current I_{AUX}.

In FIG. 12, the transistor 50 is depicted as an n-channel MOSFET (NFET or NMOS transistor). However, other types of transistors may also be used. For example, in embodiments where the output voltage of the auxiliary power supply 16 is used to power the LS drive circuits 22₁, the transistor 50 may be a p-channel transistor (PFET or PMOS transistor) with its source coupled to the cathode of the diode 52 and its drain coupled to the input of the auxiliary power supply 16. Alternatively, the transistor 50 could be a PNP bipolar junction transistor.

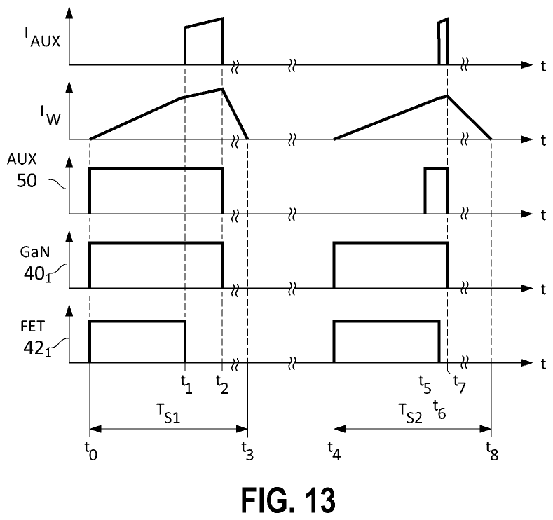

FIG. 13 is a timing diagram illustrating operation of an embodiment for diverting current from a motor winding using the circuitry shown in FIG. 12. In this embodiment, the auxiliary switch (i.e., transistor 50) determines when auxiliary current I_{AUX} is delivered to the auxiliary power supply 16 when the motor is either stationary or in motion during T_{S1} or T_{S2}.

Graph FET shows the high/low state of the transistor 42₁ corresponding to LLS switch 32₁ which, in this example, is a normally-off MOSFET. Graph GaN shows the high/low state of the transistor 40₁ corresponding to ULS switch 28₁ which, in this example, is a normally-on GaN transistor. Graph AUX shows the high/low state of the transistor 50. A high state indicates that the switch is closed (i.e., turned on), whereas a low state indicates that the switch is open (i.e., turned off). Graph I_{W} shows the winding current I_{W} in the winding of motor 14. A positive winding current I_{W} indicates current flowing from the winding of motor 14 to node 38₁, whereas a negative winding current I_{W} indicates current flowing from node 38₁ to the winding of motor 14. Graph I_{AUX} shows the auxiliary current I_{AUX} at the input to the auxiliary power supply 16.

Time duration T_{S1} illustrates when the auxiliary switch (transistor 50) and the ULS switch (GaN transistor 40₁) are controlled synchronously. At t₀, the GaN transistor 40₁, the FET 42₁, and the auxiliary switch 50 are closed. Winding current I_{W} begins to increase. At t₁, when winding current I_{W} reaches a threshold, the FET 42₁ is opened. Auxiliary current I_{AUX} is delivered to the auxiliary power supply. Winding current I_{W} continues to increase, but at a slower rate due to a decrease in the voltage across the winding. At t₂, the auxiliary switch 50 is opened, which in turn causes the GaN transistor 40₁ to open due to an increase in the voltage at the source of the GaN transistor 40₁ under the influence of the winding current I_{W}. The winding current I_{W} starts to decrease (e.g., at approximately the same rate as the increase between t₀ and t₁). At t₃, there is negligible current I_{W} in the winding.

Time duration T_{S2} illustrates when the auxiliary switch 50 and the normally-on GaN transistor 40₁ are controlled asynchronously. At t₄, the GaN transistor 40₁ and the FET 42₁ are closed. Winding current I_{W} begins to increase. At t₅, the auxiliary switch 50 is closed. At t₆, the FET 42₁ is opened. Winding current I_{W} continues to increase, but at a slower rate due to a decrease in the voltage across the winding. Auxiliary current I_{AUX} is delivered to the auxiliary power supply. At t₇, the auxiliary switch 50 is opened, which in turn causes the GaN transistor 40₁ to open due to an increase in the voltage at the source of the GaN transistor 40₁ under the influence of the winding current I_{W}. The winding current I_{W} starts to decrease (e.g., at approximately the same rate as the increase between t₄ and t₆). At t₈, there is negligible current I_{W} in the winding.

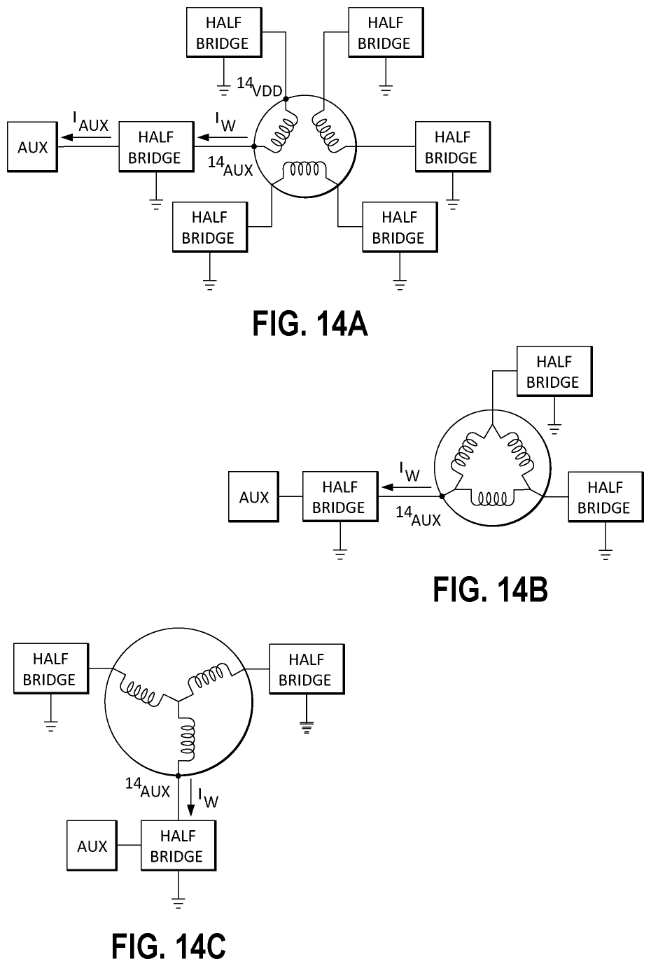

FIGS. 14A, 14B, and 14C illustrate additional embodiments of the system shown in FIG. 1. In FIGS. 14A-14C, each half-bridge motor driver circuit is coupled between the VDD power supply rail (not shown) and reference ground. Further, each winding has a first end 14_{VDD} coupled to a first half-bridge motor driver circuit (corresponding to the motor driver 12₂), and a second end 14_{AUX} coupled to a second half-bridge motor driver circuit (corresponding to the motor driver 12₁). The example in FIG. 14C features indirect coupling to a motor driver through an interposing winding. In a typical system, a single auxiliary power supply may provide power to all motor driver circuits in the system.

In FIG. 14A, the motor is a three-phase motor having three separate windings. Each winding is coupled between a respective pair of half-bridge motor drivers, which are not shared with any other winding. In the example of FIG. 14A, the current between one motor driver and another motor driver is conducted through a single winding.

In FIG. 14B, the motor has three windings coupled together in a delta-shaped (triangular) configuration. Each vertex in the delta configuration corresponds to a node formed by coupling together the adjacent ends of two windings. Each vertex is coupled to a respective half-bridge motor driver, which is shared by the two windings that form the vertex. For any particular winding, the first end 14_{VDD} of the winding and the second end 14_{AUX} of the winding are coupled to different windings. In the example of FIG. 14B, the current between any two motor drivers is conducted through all three windings.

In FIG. 14C, the motor has three windings coupled together in a Y-shaped or hub-and-spoke configuration in which a first end of each winding is coupled to a respective half bridge motor driver, while the second ends of the windings are coupled together at a central node. In this example, the current between any two half-bridge motor drivers is conducted through two windings.

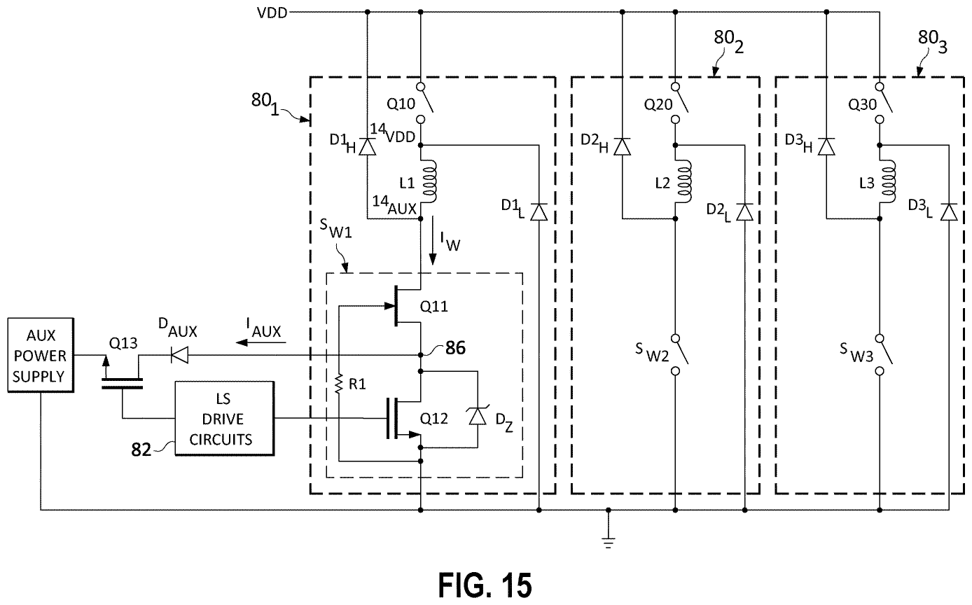

FIG. 15 is a functional block diagram in accordance with another embodiment of the present disclosure. Three circuit blocks 80₁, 80₂, 80₃ are coupled between VDD and reference ground. Circuit block 80₁ is representative of the other circuit blocks 80₂, 80₃ and includes a LS switch S_{W1} implemented as a composite switch. The circuit blocks 80₂ and 80₃ include respective LS switches S_{W2} and S_{W3}, which can also be implemented as composite switches that are similar or identical to the composite switch S_{W1} (e.g., using cascode-coupled transistors, as discussed below).

As an illustrative example, circuit block 80₁ includes a first switch Q10 coupled between VDD and the cathode of a diode D1_{L}. The anode of diode D1_{L} is coupled to reference ground. Circuit block 80₁ further includes a motor winding L1 coupled between the first switch Q10 and the composite switch S_{W1}. The motor winding L1 has a first end 14_{VDD} coupled to the first switch Q10 and a second end 14_{AUX} coupled to the composite switch S_{W1}. The opposite end of the composite switch S_{W1} is coupled to reference ground. A diode D1_{H} is coupled between VDD and the second end 14_{AUX} of the motor winding L1. The circuit blocks 80₂ and 80₃ include respective motor windings L2 and L3 arranged in a similar configuration as the winding L1.

The composite switch S_{W1} includes two transistors in a cascode configuration, e.g., a normally-on (e.g., depletion mode) transistor Q11 and a normally-off (e.g., enhancement mode) transistor Q12 coupled together at an AUX node 86. The AUX node 86 is analogous to AUX node 36₁ in FIG. 1. The transistor Q11 may be a GaN transistor, while the transistor Q12 may be a MOSFET. A Zener diode D_{Z} is coupled across the transistor Q12. A resistor R1 is coupled between the gate of transistor Q11 and reference ground.

A diode D_{AUX} is coupled between the AUX node 86 and an auxiliary switch Q13. In this example, auxiliary switch Q13 is a transistor (e.g., MOSFET) with its drain coupled to the cathode of the diode D_{AUX}. The auxiliary switch Q13 is depicted as an NMOS transistor with its source coupled to an auxiliary power supply 16 and its drain coupled to the cathode of the diode D_{AUX}. However, other types of transistors may be used to implement the auxiliary switch Q13 (e.g., a PMOS or PNP bipolar junction transistor, as discussed above with respect to the transistor 50 of FIG. 12). LS drive circuits 82 are coupled between the gate of the transistor Q12 and the gate of the auxiliary switch Q13.

To increase current in a selected winding (e.g., L1, L2, or L3), the HS and LS switches coupled to the selected winding are closed. For example, the switches Q10, Q11, and Q12 can be closed to increase current in the winding L1.

To deliver current to the auxiliary power supply, a LLS switch coupled to the selected winding is opened. For example, the LLS switch (Q12) portion of the composite switch S_{W1} can be opened to deliver current from the AUX node 86 to the auxiliary switch Q13 until the voltage at the AUX node 86 rises high enough to open the ULS switch (Q11) portion of the composite switch S_{W1}. In some embodiments, a capacitor could be coupled from the node connecting the diode D_{AUX} and auxiliary switch Q13 to reference ground, as shown with capacitor 54 in FIG. 12.

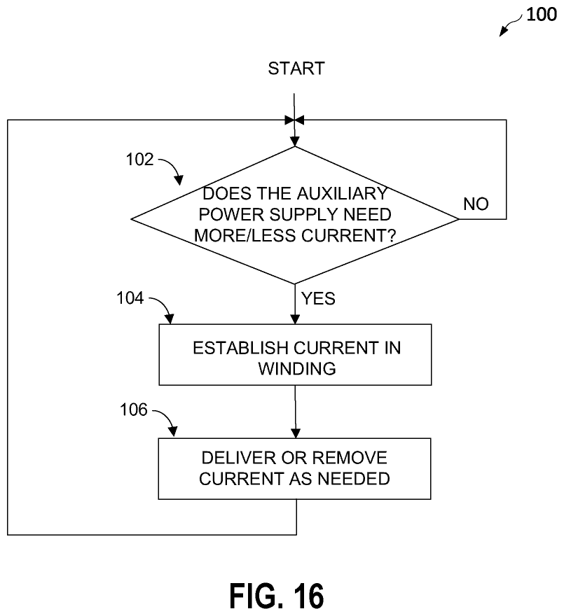

FIG. 16 is a process flowchart 100 according to an embodiment of the present disclosure. In step 102, it is determined whether the auxiliary power supply needs current. In general, the control circuitry of the motor control system (e.g., system MCU 18) can be configured to determine when and how much winding current needs to be diverted to provide a desired output voltage at the auxiliary power supply. In some situations, the auxiliary power supply may need more current (e.g., to produce a particular output voltage). In other situations, the auxiliary power supply may need less current. If no, step 102 is repeated. If yes, in step 104, current is established in the winding.

If step 104 is performed during start-up of the motor control system (e.g., when the input voltage source VDD is first made available), the winding current can be established with the aid of self-start circuits (not shown in the drawings) in the two motor drivers at opposing ends of the winding. The self-start circuits would typically be used to temporarily provide power for turning the switches on or off in an appropriate sequence to increase and divert the winding current until the auxiliary power supply becomes operational, at which point the auxiliary power supply can take over and the self-start circuits can be disabled (e.g., in response to control signals from a system MCU). In some implementations, the self-starting functionality may be provided by a bootstrap circuit in the auxiliary power supply rather than being part of the motor drivers.

In step 106, current from the winding is delivered to or removed from the auxiliary power supply as needed. In other words, the winding current is diverted in such a way that the resulting auxiliary current is either delivered to the input of the auxiliary power supply or removed from the input of the auxiliary power supply. In typical usage, the diverted current would be either delivered to produce an auxiliary output voltage that is positive with respect to a reference voltage (e.g., the input return) or removed to produce an auxiliary output voltage that is negative with respect to a reference voltage (e.g., the input return). In either case, the auxiliary current can be diverted through an auxiliary node (e.g., AUX node 86 in FIG. 15) until the current needed by the auxiliary power supply is achieved. However, a switch configuration that delivers current to the auxiliary power supply may not necessarily be able to also remove current from the auxiliary power supply, or vice versa. Accordingly, step 106 can be adapted to fit the current diversion capabilities of the motor drivers. For example, if step 106 is performed using the motor control system of FIG. 1 and the auxiliary power supply 16 does not need more current, the amount of current delivered to the auxiliary power supply can be reduced or delivery may be postponed until the auxiliary power supply needs more current.

Steps 104 and 106 can be performed by controlling the switches in one of the example motor control systems disclosed herein in accordance with a corresponding timing diagram. Additional examples to which the process flowchart 100 applies are described below with reference to the subsequent figures. These additional examples incorporate elements similar to those discussed above with reference to FIGS. 1-15. Unless indicated otherwise, similarly named and numbered elements couple and function as described above in connection with earlier examples. For the sake of brevity, the detailed descriptions of such elements are not repeated.

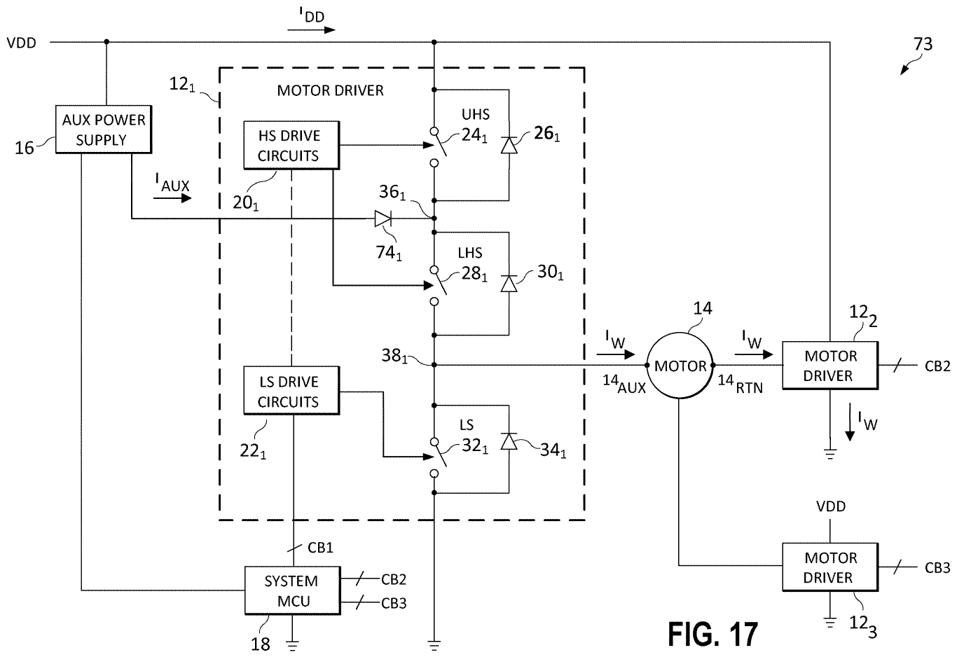

FIG. 17 is a functional block diagram 73 of a motor control system in accordance with an embodiment of the present disclosure. Like the motor control system in FIG. 1, the motor control system in FIG. 17 includes a motor 14, a set of half-bridge motor driver circuits 12₁, 12₂, 12₃, an auxiliary power supply 16, and a system MCU 18. At least one difference, however, is that the positions of the winding node 38₁ and the AUX node 36₁ are swapped relative to the positions of these nodes in FIG. 1. Additionally, each motor driver has been reconfigured to include two HS switches and one LS switch, instead of one HS switch and two LS switches. In FIG. 17, switch 24₁ is an upper high side (UHS) switch, switch 28₁ is a lower high side (LHS) switch, and switch 32₁ is a LS switch. A blocking diode 74₁ is also included which has an anode coupled to an input of the auxiliary power supply 16 and a cathode coupled to the AUX node 36₁. The diode 74₁ can be part of the motor driver 12₁ or external to the motor driver 12₁. Although the functions of the switches are no longer the same, the reference labels for the switches (e.g., 24₁, 28₁, 32₁) are reused in FIG. 17 and later drawings to denote the order in which the switches are arranged along a circuit path between an input voltage source and an input return (e.g., a path corresponding to a leg of an H-bridge).

Unlike previous examples, the example of FIG. 17 involves using high side switches (e.g., UHS switch 24₁ and LHS switch 28₁) of a motor driver to generate and divert winding current. The example of FIG. 17 can produce an auxiliary power supply that has a relatively low negative output voltage with respect to a positive input voltage source (e.g., VDD). Thus, the output voltage of the auxiliary power supply in FIG. 17 with respect to an input return (e.g., reference ground) will typically be much higher than the voltage of the auxiliary power supply in FIG. 1 with respect to the input return. Additionally, in later examples discussed below, a combination of low side and high side switches can be used to provide an auxiliary power supply with an output voltage that is negative with respect to not only VDD but also with respect to input return.

As shown in FIG. 17, the direction of the current I_{W} in a winding of the motor 14 is opposite to the direction of winding current I_{W} in previous examples such as FIG. 1. Similarly, the direction of auxiliary current I_{AUX} is opposite to I_{AUX} in FIG. 1. Further, in FIG. 17, the auxiliary power supply 16 is referenced to VDD rather than to an input return (e.g., a ground reference for the system MCU 18 and the motor drivers 12₁, 12₂, 12₃).

To increase current in the winding, the UHS switch 24₁ and the LHS switch 28₁ coupled to a second end 14_{AUX} of the motor winding are closed and LS switch 32₁ is opened. At the same time, the LS switch (not shown) in the half-bridge motor driver circuit 12₂ at a first end 14_{RTN} of the motor winding is closed. In this switching state, a current I_{DD} is conducted from VDD along the positive supply rail through the HS switches 24₁, 28₁ to establish the winding current I_{W},which is in turn conducted through the LS switch of the motor driver 12₂ to the input return.

In FIG. 17, a positive current I_{W} indicates current in the direction from the winding node 38₁ to the second end 14_{AUX} of the winding (along the direction of the arrow) whereas a negative current I_{W} indicates current flowing from the second end 14_{AUX} of the winding to the winding node 38₁ (against the direction of the arrow).

To divert the winding current I_{W},the LS switch 32₁ may remain open while the LHS switch 28₁ may remain closed and the UHS switch 24₁ is opened. The LS switch of the motor driver 12₂ remains closed to provide a path to the input return. Opening the UHS switch 24₁ diverts the winding current I_{W} as a positive current that is removed from the auxiliary power supply. In other words, the auxiliary current I_{AUX} is sunk at the AUX node 361, thereby removing current from the auxiliary power supply 16 and making the output voltage of the auxiliary power supply 16 more negative. The auxiliary current I_{AUX} could also be considered as being an equivalent negative current that is delivered to the auxiliary power supply 16. Since VDD is greater than the voltage at the auxiliary power supply 16 with respect to the input return, the diode 741 is reversed biased to block conduction of current from the positive supply rail to the auxiliary power supply 16.

As mentioned earlier, VDD is typically a high voltage dc source. For example, VDD may be hundreds of volts above the input return serving as a ground reference for the motor drivers 12₁, 12₂, 12₃ and the system MCU 18. Like the example of FIG. 1, the output voltage of the auxiliary power supply 16 in FIG. 17 can be less than VDD but greater than the input return (i.e., a voltage that is positive with respect to input return but negative with respect to VDD). For example, in FIG. 1, if VDD is +300V with respect to the input return (e.g., a 0V ground reference), the auxiliary current I_{AUX} may be controlled to provide the auxiliary power supply 16 with a regulated output voltage of +5V with respect to the input return, in which case the auxiliary power supply's voltage would be −295V with respect to VDD.

However, in addition to being high side referenced, another distinguishing feature of the auxiliary power supply in FIG. 17 compared to the auxiliary power supply in FIG. 1 is the magnitude of the output voltage with respect to input return. Whereas the output voltage in FIG. 1 is generally a relatively low positive voltage with respect to input return (e.g., an output voltage of +5V), the output voltage in FIG. 17 is generally a relatively high positive voltage with respect to input return. For example, in FIG. 17, if VDD is +300V with respect to input return, the output voltage could be +288V with respect to input return and −12V with respect to VDD.

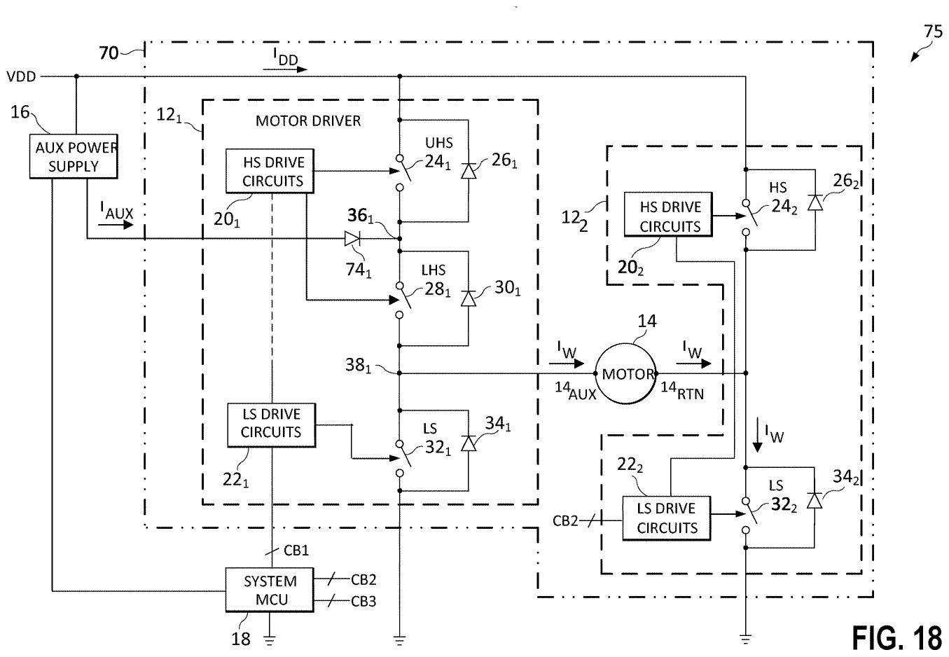

In another embodiment of the motor control system shown in FIG. 17, the LS switch 32₁ may be omitted from the motor driver 12₁. However, if both the motor driver 12₁ and the motor driver 12₂ include at least a LS switch (e.g., respective UHS, LHS, and LS switches in each motor driver), then the motor drivers 12₁, 12₂ could be used interchangeably so that winding current I_{W} can be diverted in either direction with respect to the winding of the motor 14 (e.g., so that current is removed from the input of a VDD-referenced auxiliary power supply in the motor driver 12₂). As shown in FIG. 18, the motor drivers 12₁, 12₂ do not need to have identical switching circuits.

FIG. 18 is a functional block diagram 75 showing the current path for an auxiliary power supply in a switched-mode power converter 70. The power converter 70 corresponds to an embodiment of the motor control system shown in FIG. 17. In this example, the power converter 70 includes motor drivers 12₁ and 12₂, with the motor driver 12₁ being identical to motor driver 12₁ in FIG. 17. However, instead of having both a UHS switch and a LHS switch, the motor driver 12₂ only has one HS switch 24₂ in addition to a LS switch 32₂. In another embodiment, the HS switch 24₂ may be omitted altogether to allow unidirectional current in the winding. The functionality of the motor drivers 12₁, 12₂ is the same as described above with respect to FIG. 17. To increase current in the winding, the UHS switch 24₁ and the LHS switch 28₁ of the motor driver 12₁ are closed, the LS switch 32₁ of the motor driver 12₁ is opened, and the LS switch 32₂ of the motor driver 12₂ is closed. Then to divert the winding current I_{W},the LS switch 32₁ may remain open, the LHS switch 28₁ and the LS switch 32₂ may remain closed, and the UHS switch 24₁ may be opened.

The power converter 70 can be operated according to the timing diagrams in FIGS. 3-8. However, as discussed above in connection with FIG. 17, the switches 24₁ and 28₁ are now UHS and LHS switches, respectively. Accordingly, it will be understood that the waveforms for a ULS switch (e.g., switch 28₁ in FIG. 2) are representative of the switching behavior of the LHS switch 28₁ in FIG. 18. Likewise, the waveforms for a LLS switch (e.g., switch 32₁ in FIG. 2) are representative of the switching behavior of the UHS switch 24₁ in FIG. 18. The waveforms for the LHS and UHS switches would respectively be identical to the waveforms for the ULS and LLS switches in FIGS. 3-8. The waveforms for the auxiliary current I_{AUX} and the winding current I_{W} would remain unchanged.

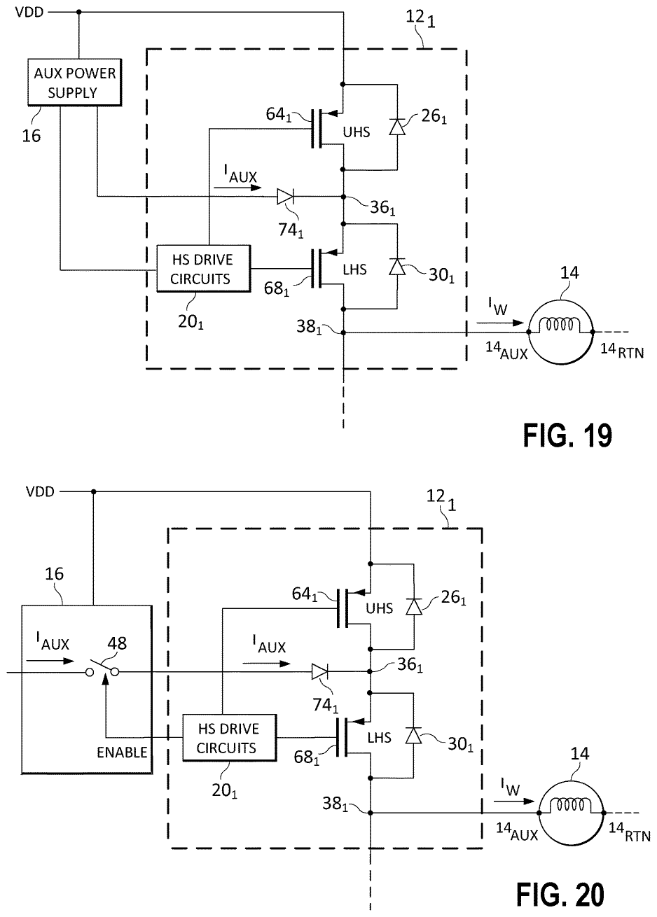

FIGS. 19-21 are circuit schematics of various embodiments of the half-bridge motor driver 12₁ shown in FIG. 17. The schematics in FIGS. 19-21 are derived from the example schematics in FIGS. 9-12, particularly FIGS. 9, 11, and 12. In FIGS. 19-21, the UHS and LHS switches are respectively implemented using transistors 64₁ and 68₁. One of ordinary skill in the art would recognize the correspondence between the UHS switch (transistor 64₁) and the LLS switch (transistor 42₁) from the previous drawings, as well as the correspondence between the LHS switch (transistor 68₁) and the ULS switch (transistor 40₁).

FIG. 19 is a circuit schematic of an embodiment of the half-bridge motor driver 12₁ shown in FIG. 17. In this example, the UHS switch 24₁ is implemented using a normally-off (e.g., enhancement mode) transistor 64₁, and the LHS switch 28₁ is implemented using a normally-off transistor 68₁. In some embodiments, the HS transistors 64₁, 68₁ are p-channel MOSFETs. The control terminals (e.g., gates) of the HS transistors 64₁, 68₁ are controlled using switching signals from HS drive circuits 201, which are powered by the auxiliary power supply 16. The auxiliary power supply 16 is referenced to VDD, and the auxiliary current I_{AUX} is removed from the auxiliary power supply 16 though the AUX node 361. The source of the transistor 64₁ is coupled to VDD. The drain of the transistor 64₁ is coupled to the AUX node 36₁ and the source of the transistor 68₁. The drain of the transistor 68₁ is coupled to the second end 14_{AUX} of the motor winding.

FIG. 20 is a circuit schematic of an embodiment of the half-bridge motor driver 12₁ shown in FIG. 17. Like in FIG. 11, the auxiliary power supply 16 includes an auxiliary switch 48 coupled between the AUX node 36₁ and an input of the auxiliary power supply 16. However, in this case, the ENABLE signal to the auxiliary switch 48 is provided by the HS drive circuits 201.

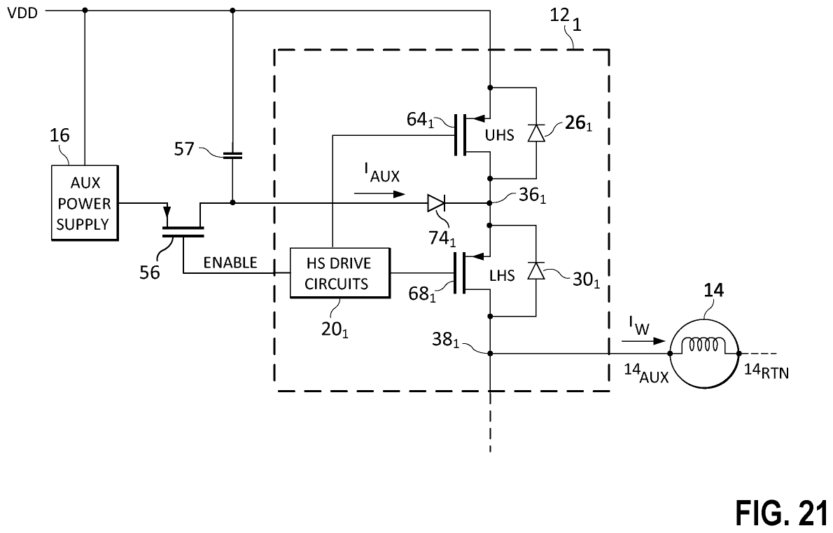

FIG. 21 is a circuit schematic of an embodiment of the half-bridge motor driver 12₁ shown in FIG. 17. In FIG. 21, a normally-off transistor 64₁ and a normally-off transistor 68₁ couple and function in a similar manner as in the example of FIG. 20. However, the auxiliary switch 48 is implemented using a transistor 56 (e.g., a MOSFET) and is external to the auxiliary power supply 16. Further, the example of FIG. 21 includes a capacitor 57. The transistor 56 and the capacitor 57 are respectively analogous to transistor 50 and capacitor 54 in FIG. 12 and function in a similar manner. However, the capacitor 57 of FIG. 21 is coupled between the anode of the diode 74₁ and VDD. The diode 74₁ functions in a similar manner as the diode 52 in FIG. 12 but is oriented in the opposite direction. Additionally, the transistor 56 is depicted as a p-channel MOSFET, with a drain of transistor 56 being coupled to the anode of the diode 74₁ and a source coupled to the auxiliary power supply 16. When the transistor 56 is open, all the auxiliary current I_{AUX} is removed from the capacitor 57. When the transistor 56 is closed, a portion of the auxiliary current I_{AUX} is removed from the capacitor 57, while the remaining portion is removed from the auxiliary power supply 16 through transistor 56.

In the examples of FIGS. 19-21, the transistors 64₁ and 68₁ are depicted as p-channel MOSFETs that are controlled using switching signals from HS drive circuits 20₁. To generate negative gate-to-source voltages for turning on the p-channel transistors 64₁, 68₁, the HS drive circuits 20₁ of FIGS. 19-21 may be referenced to the input return (shown in FIG. 17). In alternative embodiments, the auxiliary power supply 16 and the HS drive circuits 20₁ may be referenced to VDD, for example, when the ENABLE signal of FIG. 20 or FIG. 21 is provided by the LS drive circuits 22₁ shown in FIG. 17 instead of being provided by the HS drive circuits 20₁.

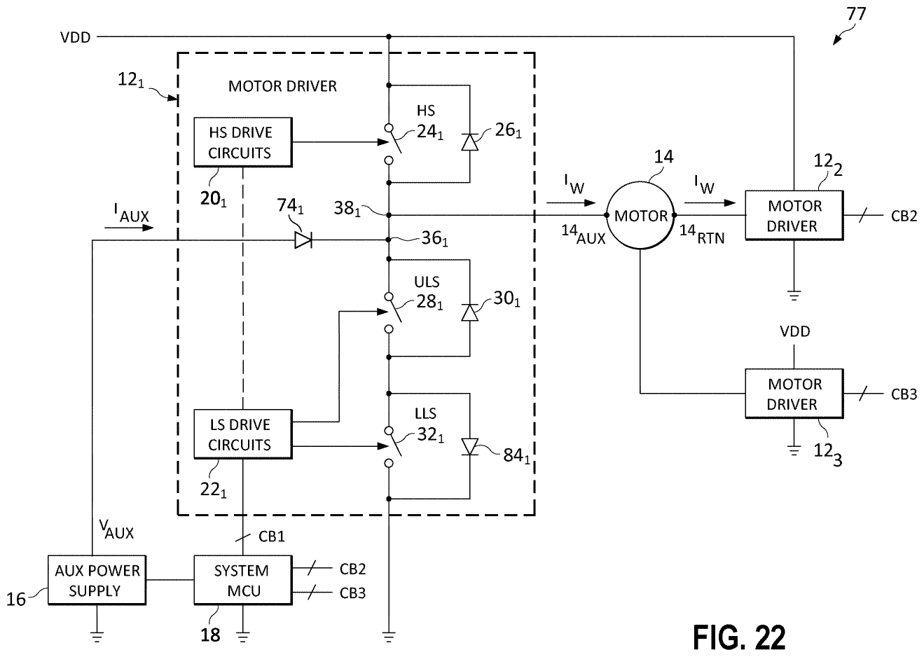

FIG. 22 is a functional block diagram 77 of a motor control system in accordance an embodiment of the present disclosure. Like the motor control system in FIG. 1, the motor control system in FIG. 22 includes a motor 14, a set of half-bridge motor driver circuits 12₁, 12₂, 12₃, an auxiliary power supply 16 referenced to input return, and a system MCU 18. Also like in FIG. 1, the motor driver 12₁ includes a HS switch 24₁,a ULS switch 28₁,and a LLS switch 32₁. At least one difference, however, is that the LLS switch 32₁ of FIG. 22 is coupled in parallel with a diode 84₁ oriented in the opposite direction to the diode 34₁ in FIG. 1. Further, in FIG. 22, the AUX node 36₁ is electrically tied to the winding node 38₁ such that the nodes 36₁, 38₁ are functionality a single node. However, in another embodiment, the AUX node 36₁ could be in the same position as in FIG. 1, i.e., located between the ULS switch 28₁ and the LLS switch 32₁.

The example of FIG. 22 also shares certain aspects of the motor control system in FIG. 17. As with FIG. 17, the winding current is diverted by removing a positive auxiliary current I_{AUX} (equivalent to delivering a negative auxiliary current). In FIG. 22, a positive current I_{W} indicates current in the direction from the winding node 38₁ to a second end 14_{AUX} of the winding (along the direction of the arrow) whereas a negative current I_{W} indicates current flowing from the second end 14_{AUX} of the winding to the winding node 38₁ (against the direction of the arrow). Also like in FIG. 17, a blocking diode 74₁ is included which has an anode coupled to an input of the auxiliary power supply 16 and a cathode coupled to the AUX node 36₁. As discussed above, the output voltage of the auxiliary power supply in FIG. 17 can be a relatively low negative voltage with respect to an input voltage source (e.g., VDD) while still being positive with respect to input return. While it is possible to produce an output voltage that is negative with respect to input return using the switching configuration shown in FIG. 17, in typical motor drive applications, the circuit components would need to withstand significantly higher voltages. For example, a storage capacitor similar to, but with a significantly higher voltage rating than, the capacitor 57 of FIG. 21 would be required in addition to higher-voltage rated switches (e.g., MOSFETs with higher avalanche breakdown voltages). The increase in component size and cost would make the use of such components impractical in an actual circuit implementation. In contrast, the example of FIG. 22 is better suited for providing the auxiliary power supply 16 with an output voltage that is negative with respect to input return.

To increase current in the winding, the HS switch 24₁ is closed while the ULS switch 28₁ is opened. The LLS switch 32₁ can be either opened or closed during this ramp-up period since the opening of the ULS switch 28₁ is sufficient to prevent current from conducting through either low side switch 28₁, 32₁. The first end 14_{RTN} of the motor winding may be electrically connected to input return via the closing of one or more low side switches in another motor driver (e.g., a ULS switch and a LLS switch in either the motor driver 12₂ or the motor driver 12₃).

A distinguishing feature of FIG. 22 and other examples that provide a negative output voltage with respect to input return is that the auxiliary current I_{AUX} is always decreasing during the diversion period (i.e., the duration in which auxiliary current is delivered to or removed from the auxiliary power supply), because the winding current I_{W} is diverted after ramp-up (i.e., after I_{W} has increased to its peak value). In contrast, I_{AUX} is always increasing during the diversion period in examples that provide a positive output voltage with respect to input return (e.g., the examples of FIGS. 1 and 17), because in those examples the diversion period coincides with at least a portion of the ramp-up period.

To stop the ramp-up of the winding current I_{W} in FIG. 22, the HS switch 24₁ may be opened, which causes the winding current I_{W} to begin decreasing. After the HS switch 24₁ is opened, the ULS switch 28₁ and the LLS switch 32₁ may be opened and closed in specific sequences to divert the decreasing winding current I_{W} and provide an output voltage that is negative with respect to the input return. In one example, the ULS switch 28₁ and the LLS switch 32₁ are initially closed at the time of opening the HS switch 24₁. In that case, the ULS switch 28₁ and the LLS switch 32₁ may be opened simultaneously or sequentially (i.e., one after the other) to divert the winding current I_{W}. The motor driver at the first end 14_{RTN} of the motor winding can retain the same switching state during the diversion period as during the ramp-up period. For example, the LS switch(es) of the motor driver 12₂ or the motor driver 12₃ may remain closed while the auxiliary current I_{AUX} is being removed from the auxiliary power supply 16.

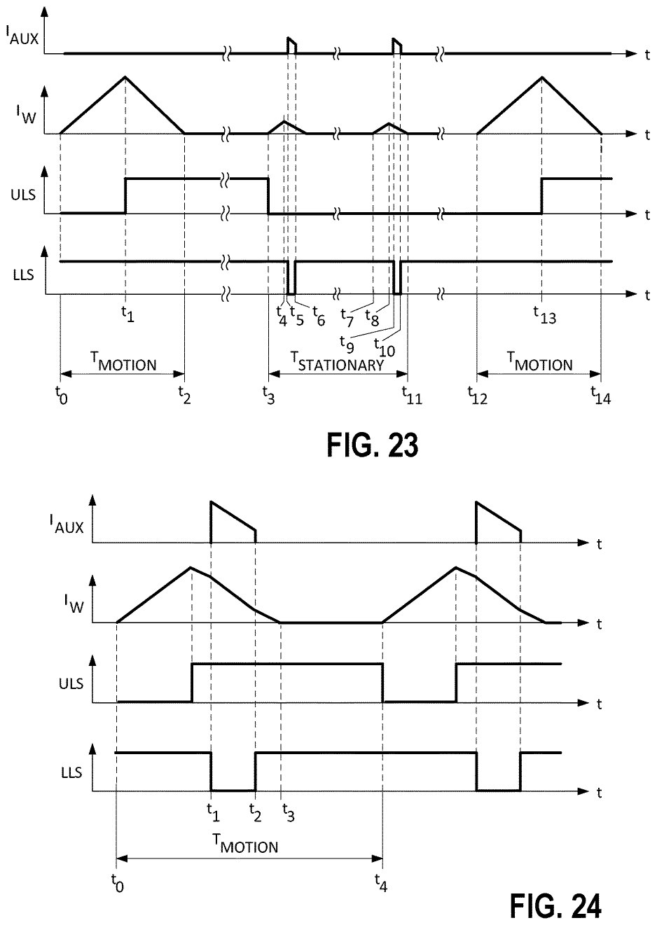

FIGS. 23-24 are timing diagrams illustrating operation of embodiments for obtaining an auxiliary current I_{AUX} from the winding current I_{W} in the motor winding as shown in the example functional block diagram of FIG. 22. In operation, the winding current I_{W} may be increased without generating continuous motor motion when the motor is stationary and the switching circuitry is configured to remove auxiliary current I_{AUX}. The winding current I_{W} may be increased above a threshold that generates motor motion when the motor is in motion and the switching circuitry is configured to remove auxiliary current I_{AUX}.

FIG. 23 is a timing diagram illustrating operation of an embodiment for obtaining current from a motor winding. In FIG. 23, Graph LLS shows the state of the LLS switch 32₁ in the functional block diagram of FIG. 22. Graph ULS shows the state of the ULS switch 28₁ in the functional block diagram of FIG. 22. Graph I_{W} shows the current in the winding of motor 14. Graph I_{AUX} shows current at the input to the auxiliary power supply 16. The waveform for the HS switch 24₁ in the motor driver 12₁ is omitted for simplicity.

For the purposes of discussing FIG. 23 and other examples based on FIG. 22, when a positive current I_{W} is present and increasing in the motor winding, it is assumed that the HS switch or switches (e.g., a HS switch 24₂, not shown) in the motor driver 12₂ coupled to the first end 14_{RTN} of the motor winding are open, and that the LS switch or switches (e.g., a ULS switch 28₂ and a LLS switch 32₂, not shown) in the motor driver 12₂ coupled to the first end 14_{RTN} of the motor winding are closed in order to provide a path for current from VDD through the motor winding and toward the input return (e.g., reference ground). In keeping with the arrow convention described above, the winding current I_{W} and the auxiliary current I_{AUX} are shown as being positive in magnitude. However, as explained above, I_{AUX} is removed from the auxiliary power supply 16 to produce a negative output voltage with respect to input return.

In FIG. 23, auxiliary current I_{AUX} is removed from the input of the auxiliary power supply 16 when the motor 14 is stationary during the duration T_{STATIONARY}. Times t₀ to t₂ correspond to a first instance of the duration T_{MOTION}. At t₀, the ULS switch 28₁ is open, the HS switch 24₁ and the LLS switch 32₁ are closed, and winding current I_{W} from the HV dc bus VDD begins to increase in the winding. Alternatively, the LLS switch 32₁ may remain open from t₀ to t₁.

At t₁, the HS switch 24₁ is opened, the ULS switch 28₁ is closed, and the LLS switch 32₁ remains closed (or is closed). Additionally, the LS switch(es) of the motor driver 12₂ coupled to the first end 14_{RTN} of the motor winding are opened to allow the winding current I_{W} to return to VDD through a high side component of the motor driver 12₂ (e.g., a switch or parallel coupled diode, analogous to HS switch 24₁ or diode 26₁ of the motor driver 12₁). The winding current I_{W} begins to decrease.

At t₂, the winding current I_{W} reaches its lowest value and there is negligible current in the winding.

Times t₃ to t₁₁ correspond to the duration T_{STATIONARY}. The duration t₃ to t₄ represents a ramp-up period in which the winding current I_{W} is increased without causing continuous motion of the motor (i.e., the motor remains stationary for all or nearly all of T_{STATIONARY}). At t₃, the ULS switch 28₁ is open, the HS switch 24₁ and the LLS switch 32₁ are closed, and winding current I_{W} from the HV dc bus VDD begins to increase in the winding.

At t₄, the HS switch 24₁ is opened, the ULS switch 28₁ remains open, the LLS switch 32₁ remains closed, and the winding current I_{W} begins to decrease. The winding current I_{W} is sustained by conduction through the LLS switch 32₁ (now closed) and the diode 30₁ that is in parallel with the ULS switch 28₁. Alternatively, the ULS switch 28₁ may be closed to reduce conduction loss by avoiding conduction through the diode 30₁. Additionally, at t₄, the LS switch(es) of the motor driver 12₂ coupled to the first end 14_{RTN} of the motor winding are opened to allow the winding current I_{W} to return to VDD through the high side component (e.g., switch or parallel coupled diode) of the motor driver 12₂.

At t₅, when winding current I_{W} reaches a threshold, the HS switch 24₁ and the ULS switch 28₁ remain open, and the LLS switch 32₁ is opened to divert the winding current I_{W} as a positive auxiliary current I_{AUX} that is removed from the auxiliary power supply 16. The auxiliary current I_{AUX} is equal to the winding current I_{W}. In another embodiment, only a part of the winding current I_{W} is diverted and the auxiliary current I_{AUX} is a portion of I_{W}.

The waveforms for I_{AUX} and I_{W} in FIG. 23 are based on the assumption that at least one of the LS switches (e.g., the ULS switch 28₂, not shown) of the motor driver 12₂ coupled to the first end 14_{RTN} of the motor winding is opened at t₁ (during T_{MOTION}) and also at t₄ (during T_{STATIONARY}) to allow the winding current I_{W} to return to VDD through the high side component of the motor driver 12₂. However, it is possible to keep the LS switch(es) of the motor driver 12₂ closed so that the winding current I_{W} returns to the input return instead of VDD. In that case, the slopes of I_{AUX} and I_{W} during a ramp-down period (e.g., between t₁ and t₂, or between t₄ and t₆) would be close to zero but still negative. The LS switch(es) of the motor driver 12₂ would eventually be opened (e.g., sometime after t₆) to bring the winding current I_{W} to zero quickly.

At t₆, the LLS switch 32₁ is closed to interrupt the removal of the auxiliary current I_{AUX}. The winding current I_{W} continues to decrease until it reaches a value of substantially zero.

The duration t₇ to t₈ represents another ramp-up period in which the winding current I_{W} is increased without causing continuous motion of the motor. The switching operations from t₇ to t₈ are identical to those in t₃ to t₄. Likewise, the duration t₈ to t₁₀ is analogous to the duration t₄ to t₆, with the winding current I_{W} being diverted between t₉ and t₁₀ to remove auxiliary current I_{AUX} from the input of the auxiliary power supply 16.

Times t₁₂ to t₁₄ correspond to a second instance of the duration T_{MOTION}. The switching operations from t₁₂ to t₁₄ are identical to those in t₀ to t₂.

FIG. 24 is a timing diagram illustrating operation of an embodiment for obtaining current from a motor winding. FIG. 24 represents an alternative switching sequence for the motor control system of FIG. 22. As with the example of FIG. 23, the waveform for the HS switch 24₁ in the motor driver 12₁ is omitted for simplicity.

In FIG. 24, auxiliary current I_{AUX} is removed from the input of the auxiliary power supply 16 when the motor 14 is in motion during time T_{MOTION}. Specifically, the auxiliary current I_{AUX} is removed between t₁ and t₂. As with FIG. 23, the LLS switch 32₁ is opened to divert the winding current I_{W}. However, unlike in FIG. 23, the ULS switch 28₁ is closed between t₁ and t₂ and remains closed until the events of t₀ to t₃ are repeated starting at time t₄.

When the winding current I_{W} is being diverted between t₁ and t₂, the winding current I_{W} decreases at a faster rate compared to when I_{W} is not diverted (e.g., from the time the winding current I_{W} starts to decrease to t₁, or between t₂ and t₃). This is because when both the ULS switch 28₁ and the LLS switch 32₁ are closed, current is conducted from the input return to VDD, and the voltage across the winding is VDD minus the input return voltage, e.g., VDD-0V. In contrast, when the LLS switch 32₁ is open (e.g., at t₁), current is conducted from the auxiliary power supply 16 to VDD, and the voltage across the winding is approximately VDD minus a negative voltage V_{AUX} at the input of the auxiliary power supply, e.g., VDD-(−V_{AUX}), ignoring the small voltage drop across the diode 74₁. Thus, the voltage across the winding becomes greater than VDD (e.g., a 15V increase when V_{AUX} equals −15V), causing the winding current I_{W} to decrease at a faster rate.

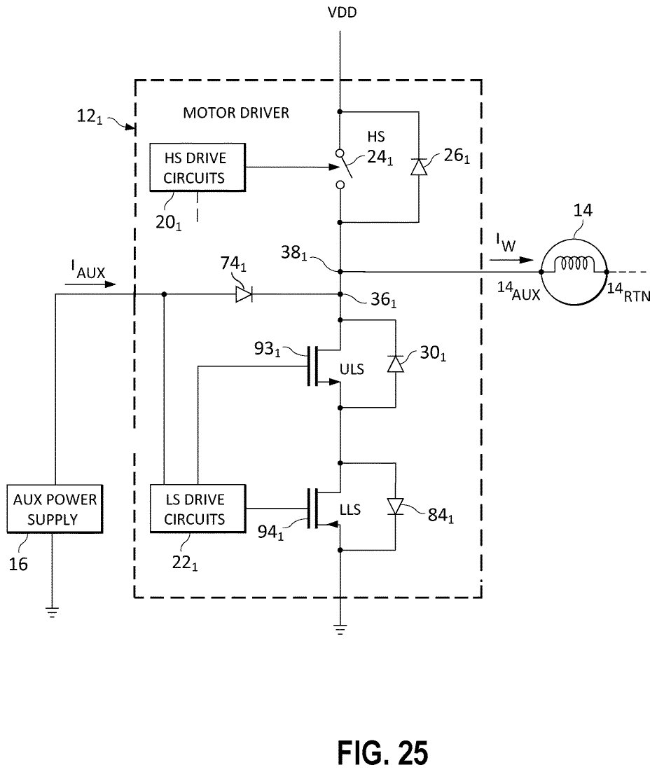

FIG. 25 is a circuit schematic of an embodiment of the half-bridge motor driver 12₁ shown in FIG. 22. In this example, the ULS switch 28₁ is implemented using a normally-off (e.g., enhancement mode) transistor 93₁, and the LLS switch 32₁ is implemented using a normally-off transistor 94₁. In some embodiments, the LS transistors 93₁, 94₁ are MOSFETs. For example, the transistor 93₁ can be an n-channel MOSFET (NFET or NMOS transistor), and the transistor 94₁ can be a p-channel MOSFET (PFET or PMOS transistor). The control terminals (e.g., gates) of the LS transistors 93₁, 94₁ are controlled using switching signals from LS drive circuits 22₁.To generate a negative gate-to-source voltage for the LLS transistor 94₁, the LS drive circuits 22₁ can be supplied with the negative output voltage of the auxiliary power supply 16. Similarly, a positive gate-to-source voltage can be generated for the ULS transistor 93₁ by providing the LS drive circuits 22₁ with a positive supply voltage from a separate auxiliary power supply (not shown). The auxiliary power supply 16 is referenced to input return, and the auxiliary current I_{AUX} is removed through the AUX node 36₁. The source of the transistor 94₁ is coupled to the input return. The drain of the transistor 94₁ is coupled to the source of the transistor 93₁. The drain of the transistor 93₁ is coupled to the second end 14_{AUX} of the motor winding.

To divert the winding current I_{W} using a PMOS transistor 94₁, the LS drive circuits 22₁ may apply a positive gate voltage to open (turn off) the PMOS transistor 94₁ (e.g., at t₅ in FIG. 23 or t₁ in FIG. 24) at or shortly after the opening of the HS switch 24₁. To discontinue or interrupt diversion of winding current I_{W},the LS drive circuits 22₁ may apply a negative gate voltage to close (turn on) the PMOS transistor 941 (e.g., at t₆ in FIG. 23 or t₂ in FIG. 24).

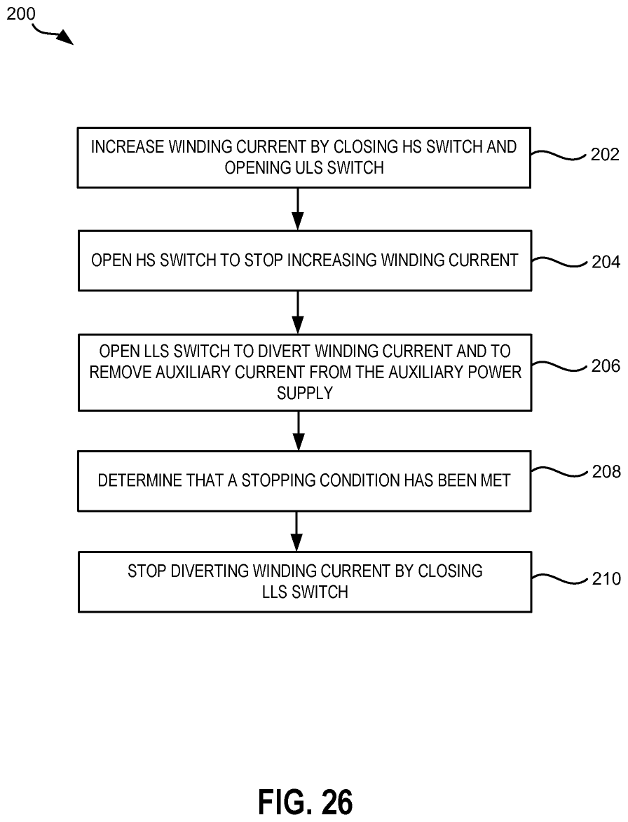

FIG. 26 is a process flowchart 200 according to an embodiment of the present disclosure. The process flowchart 200 illustrates a method of providing an auxiliary power supply with a negative output voltage with respect to an input return, using current from a winding of a motor. In some embodiments, the functionality shown in FIG. 26 may be performed using control circuitry of the motor control system in FIG. 22 and may correspond to steps 104 and 106 of FIG. 16. The control circuitry may include the system MCU 18 and drive circuitry of at least one motor driver (e.g., HS and LS drive circuits of the motor driver 12₁).

In step 202, a winding current is increased by closing a HS switch and opening a ULS switch. For example, in FIG. 22, the HS switch 24₁ of the motor driver 12₁ may be closed together with a LS switch of the motor driver 12₂ to increase the winding current I_{W}. In some instances, step 202 may be performed in response to a determination that current needs to be removed from the auxiliary power supply during a time when the motor is stationary (e.g., in response to the determination in step 102 of FIG. 16 and during T_{STATIONARY} in FIG. 23). In other instances, step 202 may be performed in response to a decision to initiate motion of the motor (e.g., T_{MOTION} in FIG. 24).

In step 204, the HS switch is opened to stop increasing the winding current (e.g., once the winding current reaches a target peak value). The opening of the HS switch causes the winding current to start decreasing (e.g., at t₄ in FIG. 23). In some instances, step 204 may also involve closing the ULS switch (e.g., sometime between t₀ and t₁ in FIG. 24).

In step 206, a LLS switch (e.g., LLS switch 32₁ in FIG. 22) is opened to divert the winding current and to remove current from the auxiliary power supply. Together with the opening of the HS switch in step 204, the opening of the LLS switch causes at least a portion of the winding current to be diverted such that auxiliary current starts being removed from the input of the auxiliary power supply. In some embodiments, a LS switch of a motor driver at the opposite end of the winding (e.g., the motor driver 12₂) may also be opened at or around this time (e.g., sometime between t₄ and t₅ in FIG. 23).

In step 208, it is determined that a stopping condition has been met. The stopping condition can be set using one or more control parameters such as time or rate of current diversion. In one example, the winding current may be diverted for a fixed duration at a variable rate of repetition (e.g., every other switching cycle, three consecutive switching cycles, etc.). In another example, the winding current may be diverted for a variable duration at a fixed rate. The control circuitry (e.g., system MCU 18) can set the stopping condition based on the needs of the auxiliary power supply. For instance, the control circuitry may determine how long it would take to bring the output voltage of the auxiliary power supply to its regulated value when the winding current is being diverted at a fixed duration, so that the output voltage is brought to regulation within a number of consecutive switching cycles. For instance, the timing diagram of FIG. 23 could be a result of determining that regulation can be achieved across two consecutive switching cycles when the winding current is diverted for the same length of time in each switching cycle (e.g., between t₅ to t₆ and between t₉ to t₁₀). Alternatively, the control circuitry may determine that the winding current should be diverted using a variable duration over the course of two or more switching cycles.

In step 210, the diversion of the winding current is stopped by closing the LLS switch. Steps 202 to 210 may be repeated. After the LLS switch is closed, the other switches of the motor driver (e.g., the HS switch 24₁ and ULS switch 28₁ of motor driver 12₁ in FIG. 22) can remain in their existing states until the next time a decision to increase the winding current is made (e.g., the next repetition of step 202).

There are alternative switching sequences not shown in the drawings (e.g., the timing diagrams of FIGS. 3-8, 13, 23, and 24) that may divert the winding current for the same purposes. In the illustrated sequences, the diversion of winding current is generally accomplished by switching the switches of only one motor driver circuit that is coupled to one end of a motor winding. The other motor driver circuits in the system do not need to change switching states during the switching sequence.

However, as discussed above in connection with FIG. 23, an alternative switching sequence could, for example, involve switching a motor driver at the opposite end of the motor winding depending on whether it is desired to let the winding current decrease at a relatively fast rate or to instead keep the winding current relatively flat (e.g., with a slope close to zero). In some instances, the switching sequence may be configured such that the winding current does not increase or decrease significantly during the diversion period, but merely circulates in the winding as it is diverted. Since the voltage across the winding would be a relatively low voltage across the input to the auxiliary power supply during this interval, the slope of the winding current would be close to zero but still negative.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

These modifications can be made to examples of the invention in light of the above detailed description. The terms used in the following claims should not be construed to limit the invention to the specific embodiments disclosed in the specification and the claims. Rather, the scope is to be determined entirely by the following claims, which are to be construed in accordance with established doctrines of claim interpretation. The present specification and figures are accordingly to be regarded as illustrative rather than restrictive.

What is claimed is:

1. A motor driver for coupling to an auxiliary power supply and to a winding of a motor, the motor driver comprising:
a switching circuit comprising at least one high side switch, at least one low side switch, and an auxiliary node coupled to the auxiliary power supply; and
control circuitry coupled to the switching circuit, the control circuitry being configured to apply a switching sequence to the switching circuit, wherein:
the switching sequence causes a winding current conducted through the winding of the motor to increase and store energy in an inductance of the winding, and
the switching sequence further causes at least a portion of the winding current to be diverted through the auxiliary node and delivered to or removed from the auxiliary power supply.

2. The motor driver of claim 1, wherein:
to increase the winding current, the control circuitry is configured to close the at least one high side switch and open the at least one low side switch; and
to divert the winding current, the control circuitry is configured to open one or more switches of the switching circuit, the one or more switches comprising a high side switch, a low side switch, or both a high side switch and a low side switch.

3. The motor driver of claim 1, wherein:
the at least one high side switch comprises an upper high side (UHS) switch coupled to a lower high side (LHS) switch;
the at least one low side switch comprises a first low side (LS) switch; and
the switching circuit further comprises a winding node coupled to one end of the winding, the winding node being located between the LHS switch and the first LS switch.

4. The motor driver of claim 3, wherein:
to increase the winding current, the control circuitry is configured to close the UHS switch, close the LHS switch, and open the first LS switch; and
to divert the winding current, the control circuitry is configured to open the UHS switch while keeping the LHS switch closed and the first LS switch open.

5. The motor driver of claim 3, wherein the switching sequence causes the winding current to be diverted while the winding current is increasing.

6. The motor driver of claim 1, wherein the at least one high side switch and the at least one low side switch are coupled together in a half-bridge configuration.

7. The motor driver of claim 1, wherein:
the at least one high side switch comprises a first high side (HS) switch;
the at least one low side switch comprises an upper low side (ULS) switch coupled to a lower low side (LLS) switch; and
the switching circuit further comprises a winding node coupled to one end of the winding, the winding node being located between the first HS switch and the ULS switch.

8. The motor driver of claim 7, wherein the auxiliary node is located between the first HS switch and the ULS switch or between the ULS switch and the LLS switch.

9. The motor driver of claim 7, wherein:
to increase the winding current, the control circuitry is configured to close the first HS switch and open the ULS switch; and
to divert the winding current, the control circuitry is configured to open the first HS switch and the LLS switch.

10. The motor driver of claim 7, wherein the switching sequence causes the winding current to be diverted after the winding current has increased to a peak value.

11. The motor driver of claim 7, wherein the switching sequence causes the at least a portion of the winding current to be removed from the auxiliary power supply, and wherein an output voltage of the auxiliary power supply is negative with respect to an input return of the motor driver.

12. A system comprising:
a motor comprising a winding;
an auxiliary power supply;
a first motor driver including a first switching circuit coupled to a first end of the winding, the first switching circuit comprising a low side (LS) switch;
a second motor driver including a second switching circuit, the second switching circuit comprising:
a high side (HS) switch,
an upper low side (ULS) switch,
a lower low side (LLS) switch,
an auxiliary node coupled to the auxiliary power supply, and
a winding node coupled to a second end of the winding, the winding node being located between the HS switch and the ULS switch; and
control circuitry coupled to the first motor driver and the second motor driver, the control circuitry being configured to apply a switching sequence to at least the second switching circuit, wherein:
the switching sequence causes a winding current conducted through the winding of the motor to increase and store energy in an inductance of the winding, and
the switching sequence further causes at least a portion of the winding current to be diverted through the auxiliary node and delivered to or removed from the auxiliary power supply.

13. The system of claim 12, wherein:
to increase the winding current, the control circuitry is configured to close the HS switch and open the ULS switch; and
to divert the winding current, the control circuitry is configured to open the HS switch and the LLS switch.

14. The system of claim 13, wherein to divert the winding current, the control circuitry is further configured to:
open the LS switch of the first switching circuit to cause the winding current to return to a positive supply rail through a high side component of the first switching circuit, the high side component being a switch or diode.

15. The system of claim 13, wherein to divert the winding current, the control circuitry is further configured to:
keep the LS switch of the first switching circuit closed to cause the winding current to return to an input return through the LS switch.

16. The system of claim 12, wherein the second switching circuit further comprises:
a diode having an anode coupled to the ULS switch and a first end of the LLS switch, and a cathode coupled to a second end of the LLS switch and an input return.

17. The system of claim 12, further comprising:
a diode having an anode coupled to the auxiliary power supply and a cathode coupled to the auxiliary node.

18. The system of claim 12, wherein the switching sequence causes the winding current to be diverted after the winding current has increased to a peak value.

19. The system of claim 12, wherein the switching sequence causes the at least a portion of the winding current to be removed from the auxiliary power supply, and wherein an output voltage of the auxiliary power supply is negative with respect to an input return.

20. A control system for a motor driver having a switching circuit, the switching circuit comprising at least one high side switch, at least one low side switch, and an auxiliary node coupled to an auxiliary power supply, the control system comprising:
a controller configured to output one or more control signals according to a switching sequence that causes the switching circuit to:
increase a winding current conducted through a winding of a motor to store energy in an inductance of the winding, and
divert at least a portion of the winding current through the auxiliary node such that the at least a portion of the winding current is delivered to or removed from the auxiliary power supply.
